(19) United States
(12) Patent Application Publication
(10) Pub. No.: US 2017/0291658 A1
(43) Pub. Date: Oct. 12, 2017

(54) MODULAR TRANSPORTER

(71) Applicant: Ignio LLC, Bloomfield Hills, MI (US)

(72) Inventors: Darren W. Somerset, Bloomfield Hills, MI (US); Sunil Lall, Bloomfield Hills, MI (US)

(73) Assignee: lgnio LLC, Bloomfield Hills, MI (US)

(21) Appl. No.: 15/094,644

(22) Filed: Apr. 8, 2016

(51) Int. Cl. B62K 13/00; B62B 7/12; F16F 15/04; B62K 15/00

(52) U.S. Cl. CPC B62K 13/00; B62K 15/006; B62B 7/12; F16F 15/043

(57) ABSTRACT

A modular transporter comprises a universal chassis that can be linked with a variety of user modules. The universal chassis comprises a base that includes a quick connector and complex geometric surfaces on its sidewalls that function to secure a user module thereto. The quick connector allows for quick assembly/disassembly of a user module to and from the base of universal chassis. A plurality of suspension arms may be removeably connectable to the base such that modular transporter may be configured in a number of transport configurations. An ergonomic handle assembly may be coupled with the base for pushing, pulling, towing, etc. When disassembled, the modular transporter can be folded into a storage and/or quick fold mode and stored in a modular storage system. The modular storage system can be mounted to a trailer hitch by a linking mechanism for further transport.

### BACKGROUND

Currently in the consumer marketplace there are numerous transporter devices that offer cargo carrying utility to the consumer, such as wagons, strollers, and bicycle trailers. These separate devices offer specific and limited functions. In most cases, transporter devices are manufactured with rolling chassis that are specifically designed for a given function or purpose. Consequently, consumers have to purchase a transporter device for each specific function or purpose, and with each purchase, the transporter device includes a new rolling chassis. This lack of rolling chassis versatility for multiple utility and consumers leads to limited recyclability, non-efficient use of raw materials and resources, high opportunity cost through new purchase depreciation across the multiple bespoke products purchased, and non-efficient use of storage space to house and transport the devices.

Thus, a modular transporter device that is readily configurable to a user's changing needs is desired. An apparatus for storing and transporting such a device is similarly desired.

### SUMMARY

Many of the challenges noted above may be addressed by a modular transporter having a universal chassis that is compatible with a variety of modular user devices that offer cargo carrying utility (i.e., user modules) and that is configurable between a plurality of transport configurations. Universal chassis may comprise a base structure having a receiving quick connector configured to receive a mating quick connector located on a user module. When the quick connector is in mating engagement, the quick connector secures the user module to universal chassis, and also allows a user module to be quickly assembled/disassembled from the universal chassis. Thus, transporter versatility can be readily achieved and accomplished in a safe manner.

A universal chassis may have a base structure comprising a top, bottom, and sidewalls extending therebetween. The sidewalls of the universal chassis may comprise complex geometric surfaces that are configured to mate with engagement surfaces located on the undercarriage of a user module. The complex geometric surfaces of the sidewalls of the base may include inclined surfaces, such as tapered surfaces, to further secure a user module to a universal chassis. The complex geometric surfaces of the sidewalls may be other complex shapes or surfaces as well, including a mix of curved, flat, and inclined surfaces.

The architecture of a base of a universal chassis may be configured into many transport configurations, including a four, three, two or one-wheeled configuration, by linking a plurality of removeably connectable suspension arms to the base. This further improves the versatility of the modular transporter. Additionally, an ergonomic handle assembly coupled with the base structure of universal chassis may be adjusted and used for many different applications. Based on the mounting location of the ergonomic handle to the base, other transport configurations include: push, pull, tow, and carry transport configurations. Many combinations of transport configurations are also possible, including but not limited to a push four-wheeled configuration, a pull four-wheeled configuration, a push three-wheeled configuration, a towed or pulled two-wheeled or one-wheeled configuration. Depending on the desired application, a user may select an appropriate user module and handle mounting location to: push a modular transporter having a jogging stroller user module in a push three-wheeled transport configuration; pull a modular transporter having a wagon user module in a pull four-wheeled transport configuration; and tow a modular transporter having a child bike trailer carrier user module in a tow two or one-wheeled transport configuration, for example.

In another embodiment, modular transporter may be autonomous; meaning, it may be capable of steering and propulsion without human intervention. Autonomous transporter may comprise an autonomous universal chassis that may link with a wide range of user modules. Autonomous universal chassis may be configurable in many different transport configurations, such as a two, three, or four-wheeled transport configuration. The autonomous universal chassis may include a power source, a controller module, and propulsion devices that in combination operably power the autonomous transporter for driving. The autonomous universal chassis may also include an autonomous steering controller, an autonomous camera system, and an autonomous actuator that, in combination, operably steer the autonomous transporter without human intervention.

If desirable to store the universal chassis, in one embodiment, the wheel/tire assemblies may be folded flat. This decreases the elevation silhouette of the universal chassis and makes it easier to store. Moreover, a plurality of suspension arms that link the base of the chassis with wheel/tire assemblies may be removed to further decrease the elevation silhouette of the chassis, making the assembly even more compact for storage. Additionally, universal chassis may be folded into a quick fold mode to reduce its fore/aft profile. A universal chassis, user modules, and other items may be placed in modular storage units for storage. The modular storage units may then be organized and secured for transport by a linking mechanism that provides mechanical leverage to position the modular storage units in a transport position behind a vehicle. The linking mechanism may include a kinematic rotational joint that allows for a plurality of modular storage units to rotate to a substantially horizontal position to ensure vehicle rearview visibility.

### BRIEF DESCRIPTION OF THE DRAWINGS

FIG. 1 is a perspective view of an exemplary modular transporter;

FIG. 2 is an exemplary universal chassis of a modular transporter;

FIG. 3 is an exploded perspective view of the universal chassis of FIG. 2;

FIG. 4 is a close-up view of an exemplary base of a universal chassis;

FIG. 5 is a cross-sectional view of the mating quick connector of an exemplary user module and receiving quick connector of an exemplary universal chassis;

FIG. 6 is a cross-sectional view of the mating quick connector and receiving quick connector of FIG. 5 in full engagement with one another;

FIG. 7 depicts an exemplary user module being connected to an exemplary universal chassis of a modular transporter;

FIG. 8 illustrates the user module and base of FIG. 7 fully connected to one another;

FIG. 9 is a bottom view of an exemplary universal chassis;

FIG. 10 is a perspective view of an exemplary suspension arm being inserted into a slot;

FIG. 11 is a perspective view of the suspension arm of FIG. 10 fully inserted into a slot;

FIG. 12 shows a four-wheeled exemplary embodiment of a universal chassis;

FIG. 13 shows a three-wheeled exemplary embodiment of a universal chassis;

FIG. 14 is a front view of the universal chassis of FIG. 13;

FIG. 15 shows a two-wheeled exemplary embodiment of a universal chassis;

FIG. 16 is an exemplary knuckle/hub assembly;

FIG. 17 is a top perspective view of the knuckle/hub assembly of FIG. 16;

FIG. 18 is an exploded view of an exemplary knuckle/hub assembly;

FIG. 19 is a schematic view of the knuckle/hub assembly of FIG. 18 with the receiving cup depicted transparent;

FIG. 20 is a perspective view of the end of an exemplary suspension arm separated from its receiving cup;

FIG. 21 is a perspective view of a knuckle/hub and wheel/tire assembly showing a wheel assembly folded flat;

FIG. 22 is a view of an exemplary modular transporter in storage mode;

FIG. 23 shows an exemplary universal chassis having a quick base fold mechanism;

FIG. 24 illustrates a handle assembly of an exemplary modular transporter;

FIG. 25A depicts a close-up view of the handle assembly of the modular transporter of FIG. 24;

FIG. 25B illustrates an exemplary universal chassis in a two-wheeled transport configuration with an application adapter attached thereto;

FIG. 26 illustrates a back, left perspective view of an exemplary universal chassis having a three-wheeled transport configuration;

FIG. 27 shows a back, left perspective view of an exemplary base having a joint attached to its transverse member;

FIG. 28 is an exploded view of a universal chassis having autonomous capability;

FIG. 29 is a assembled view of the universal chassis of FIG. 28;

FIG. 30 shows a front, right perspective view of an exemplary universal chassis;

FIG. 31 shows a rear, right perspective view of the universal chassis of FIG. 30;

FIG. 32 shows an exploded view of the universal chassis of FIG. 30;

FIG. 33 shows a front, right perspective view of an exemplary universal chassis in a four-wheeled wagon transport configuration;

FIG. 34 shows a rear, right perspective view of the universal chassis of FIG. 33;

FIG. 35 shows an exploded view the universal chassis of FIG. 33 with the handle mechanism positioned at the rear of the universal chassis;

FIG. 36 shows a front, right perspective view of an exemplary base;

FIG. 37 shows a front, left perspective view of an exemplary base;

FIG. 38 shows an exemplary universal chassis in a three-wheeled short wheelbase transport configuration;

FIG. 39 shows an exemplary universal chassis in a three-wheeled long wheelbase transport configuration;

FIG. 40 shows an exemplary base having a front suspension arm inserted into a center spring seat;

FIG. 41 shows an exemplary universal chassis in a two-wheeled transport configuration;

FIG. 42 shows a front, left perspective view of an exemplary universal chassis in a one-wheel transport configuration;

FIG. 43 shows a rear, left perspective view of an exemplary universal chassis in a one-wheel transport configuration;

FIG. 44 shows a side elevation view of an exemplary universal chassis in a one-wheel transport configuration;

FIG. 45 shows a rear suspension arm being inserted into a hub assembly of a rear wheel;

FIG. 46 shows the ratchet geometry of an exemplary handle mechanism;

FIG. 47 shows an exemplary universal chassis in a three-wheeled transport configuration;

FIG. 48 shows a side view of the universal chassis of FIG. 47 in a folded storage mode;

FIG. 49 shows a rear perspective view of the universal chassis of FIG. 47 in a folded storage mode;

FIG. 50 shows an exemplary universal chassis in a four-wheeled transport configuration;

FIG. 51 shows an exemplary universal chassis in a three-wheeled transport configuration;

FIG. 52 shows an exemplary universal chassis in a two-wheeled transport configuration;

FIG. 53 shows a close-up perspective view of an exemplary base;

FIG. 54 shows an exemplary universal chassis in a three-wheeled transport configuration being folded into a folded storage mode;

FIG. 55 shows a perspective view of an exemplary universal chassis folded into a folded storage mode;

FIG. 56 shows an exemplary universal chassis in a jogging stroller transport configuration;

FIG. 57 shows an exemplary universal chassis in a walking stroller transport configuration;

FIG. 58 illustrates an exemplary spring unit coupling a suspension arm with a base;

FIG. 59 shows a perspective view of an exemplary spring unit;

FIG. 60 shows a side view of an exemplary spring unit;

FIG. 61 shows an exploded view of an exemplary spring unit;

FIG. 62 shows a side view of an exemplary spring unit;

FIG. 63 shows a perspective view of an exemplary spring unit detailing the second end plate of the assembly;

FIG. 64 shows a close-up exploded view of an exemplary axle pin, suspension arm, spring unit, and a rear outboard spring seat;

FIG. 65 shows the components of FIG. 64 fully assembled with the suspension arm shown transparent for illustrative purposes;

FIG. 66 illustrates an exemplary modular storage system with a modular transporter being stored within;

FIG. 67 illustrates the modular storage system of FIG. 66 having a linking mechanism attached thereto;

FIG. 68A is a perspective view of a side portion of an exemplary modular storage system illustrating a cam locking system of an exemplary linking mechanism;

FIG. 68B is a perspective view of an exemplary cam locking system in an unlocked position;

FIG. 68C is a cross-sectional view of the cam locking system of FIG. 68B;

FIG. 68D is a perspective view of an exemplary cam locking system in a locked position;

FIG. 68E is a cross-sectional view of the cam locking system of FIG. 68D;

FIG. 69 shows an exemplary linking mechanism;

FIG. 70 is a perspective view of two modular storage systems linked together via an exemplary linking mechanism;

FIG. 71 is a side elevation view of an exemplary linking mechanism beginning to lift modular storage systems to a ride height position;

FIG. 72 is a side elevation view of an exemplary linking mechanism that has fully lifted modular storage systems off of the ground;

FIG. 73 is a side elevation view of an exemplary linking mechanism that has lifted modular storage systems to a ride height position;

FIG. 74 illustrates an exemplary linking mechanism after it has rotated modular storage systems to a horizontal position;

FIG. 75 illustrates a perspective view of an exemplary linking mechanism linked to a vehicle showing the modular storage systems rotated ninety degrees; and

FIG. 76 shows a side elevation view of an exemplary linking mechanism linked to a vehicle showing the modular storage systems rotated ninety degrees.

### DETAILED DESCRIPTION

Multiple embodiments of a modular transporter 100 are described with reference to the drawings, wherein like numerals reference like structures. Although the modular transporter 100 may be illustrated and described herein as including particular components in a particular configuration, the components and configuration shown and described are provided for example purposes only. The figures and descriptions of the embodiments described herein are not intended to limit the breadth or the scope of the inventive concepts or the appended claims in any manner. Rather, the figures and detailed descriptions of the modular transporter 100 are provided to illustrate the inventive concepts to a person of ordinary skill in the art and to enable such person to make and use the inventive concepts.

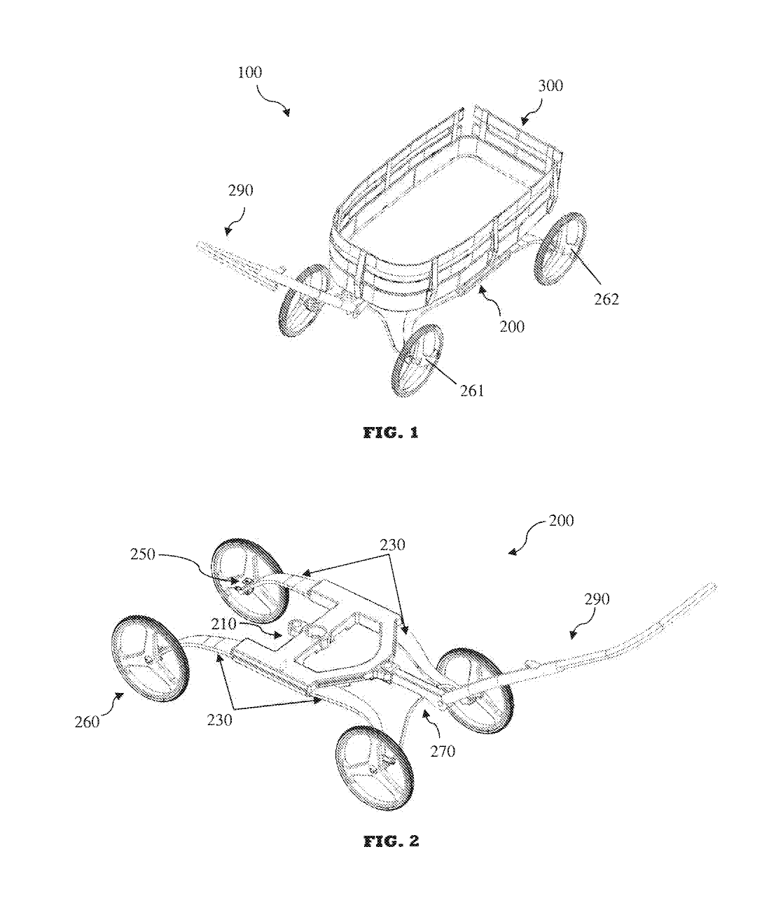

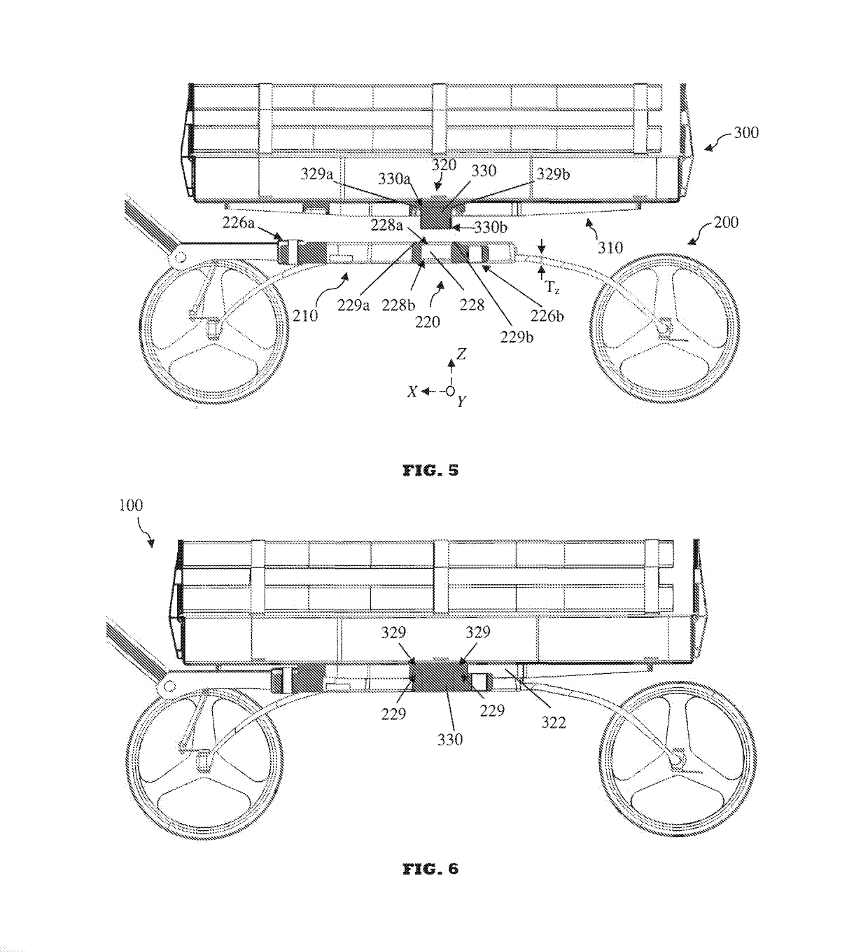

Turning now to the drawings, FIG. 1 depicts a perspective view of an exemplary modular transporter 100. The modular transporter 100 generally comprises a universal chassis 200 and a cargo carrying device that may be mounted thereto, exemplified herein as a user module 300. Universal chassis 200 provides a universal structure that may link with a variety of user modules 300 having undercarriages 310 (FIG. 5) with architecture complementary to its base 210. The universal structure of universal chassis 200 also allows it to be configured in a number of different transport configurations, such as a four-wheeled configuration or three-wheeled configuration. This provides flexibility for using the modular transporter 100 for any number of uses.

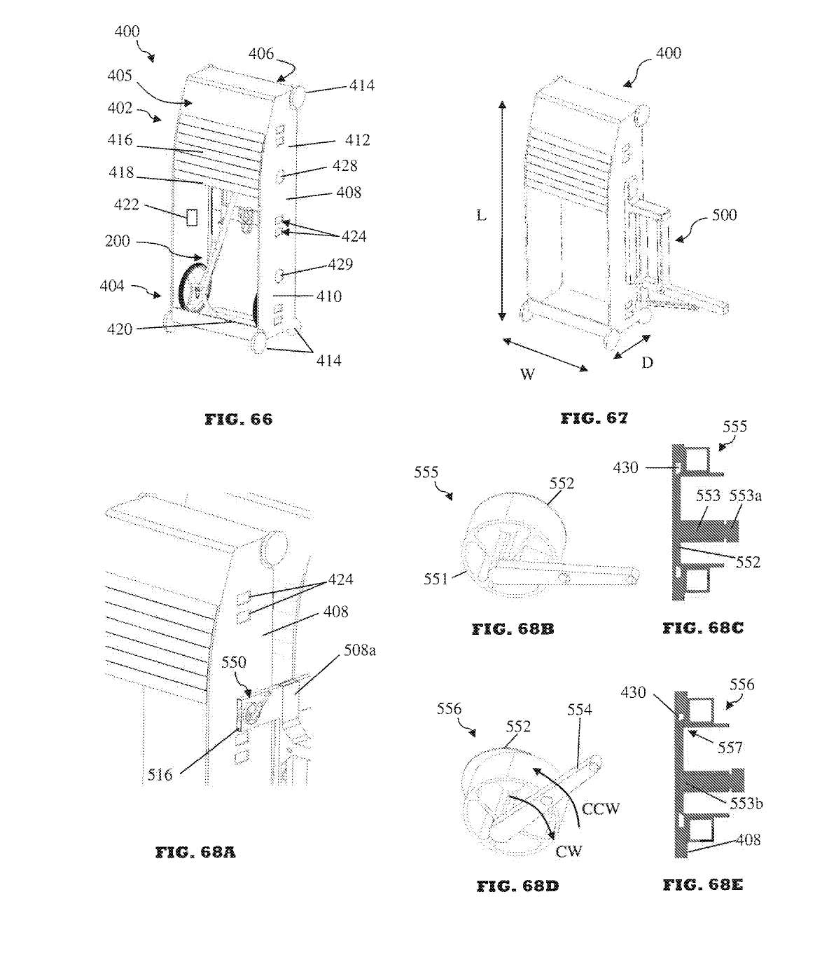

When assembled, the modular transporter 100 may be pushed, pulled, towed, or carried on multiple surface types via an ergonomic and fully adjustable handle assembly 290. For example, in FIG. 1, modular transporter 100 is shown in a four-wheeled transport configuration with a wagon as the user module 300, which may be pulled in a desired direction. When disassembled, the front and rear wheels 261, 262 of universal chassis 200 may be folded flat for transport efficiency (FIG. 22), the base 210 may be folded with a quick fold mechanism (FIG. 23), and/or stowed away in a modular storage system 400 (FIG. 66). User modules 300 and other items may also be stowed in modular storage systems 400. After universal chassis 200 and user modules 300 are stowed in modular storage systems 400, the modular storage systems 400 may then be linked together by a linking mechanism 500 that may attach to a vehicle hitch 504 or vehicle roof rack, for example. FIGS. 75 and 76 show linking mechanism 500 linking a plurality of modular storage systems 400 with a vehicle 502.

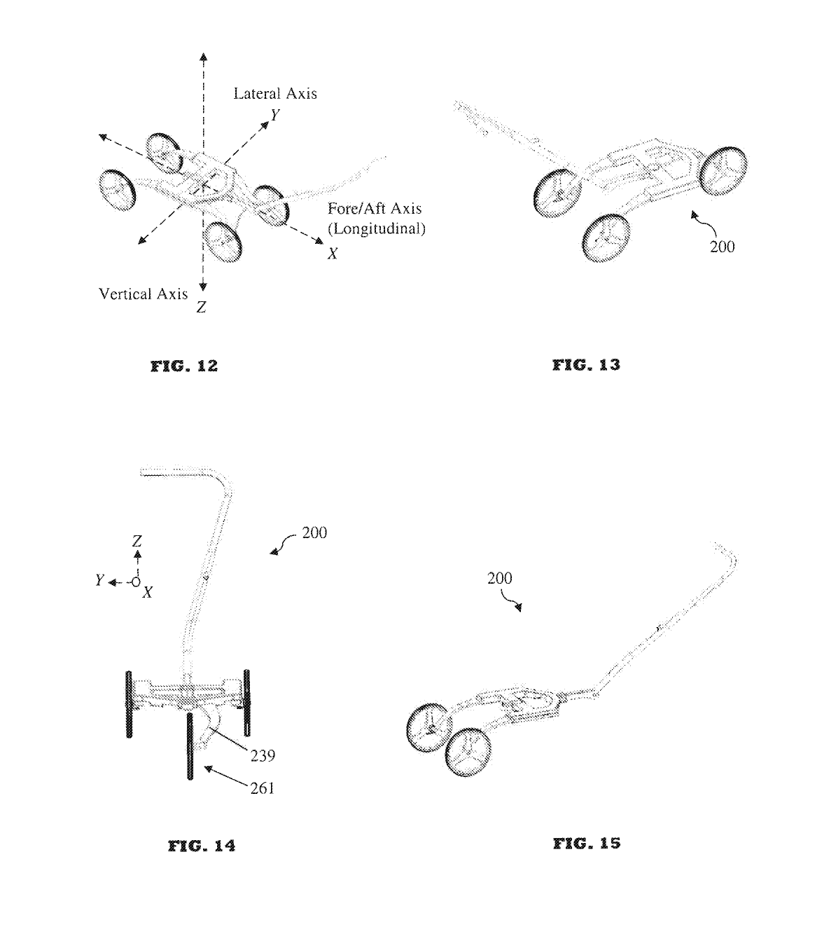

Modular transporter 100 may be readily configured for a wide range of utilities and purposes by connecting a given user module 300 to universal chassis 200, 800, 900. A quick connector/release provides for fast and simple assembly/disassembly of modular transporter 100. User modules 300 may be for any number of usage applications and can be customized to a consumer/user's needs and demographic. Exemplary user modules 300 include but are not limited to: child bike trailer carriers; child infant stroller/jogging strollers; child wagons; golf caddie carts; garden utility wagons; hunting/fishing utility wagons; general utility/equipment carriers; kayak/canoe carriers; all terrain/surface camping/hiking utility wagons; and child ride on non-powered/powered, wheelchairs, portable walkers vehicles. Depending on the selected user module 300, universal chassis 200, 800, 900 may be assembled in any number of transport configurations, as noted previously. For example, multiple transport configurations of universal chassis 200 are shown in FIGS. 12-15, including a four-wheeled transport configuration (FIG. 12), a three-wheeled transport configuration (FIGS. 13 and 14), and a two-wheeled transport configuration (FIG. 15). The four-wheeled configuration may be used for numerous lifestyle applications, such as strollers and wagons; the three-wheeled configuration may be used for applications such as jogging strollers; and the two or one-wheeled configuration may be used for a child bike trailer carrier, for example.

Modular transporter 100, universal chassis 200, and user modules 300 will be described herein with reference to three axes: a vertical axis (Z axis), a lateral axis (Y axis), and a fore/aft (longitudinal) axis (X axis). The translational movement about any of the three axes (three degrees of freedom) and the rotational movement about any of the three axes (three degrees of freedom) totals six degrees of freedom. Various elements of modular transporter 100, universal chassis 200, and user modules 300 will either move about or be constrained in these named six degrees of freedom. FIG. 12 illustrates the three named axes relative to universal chassis 200.

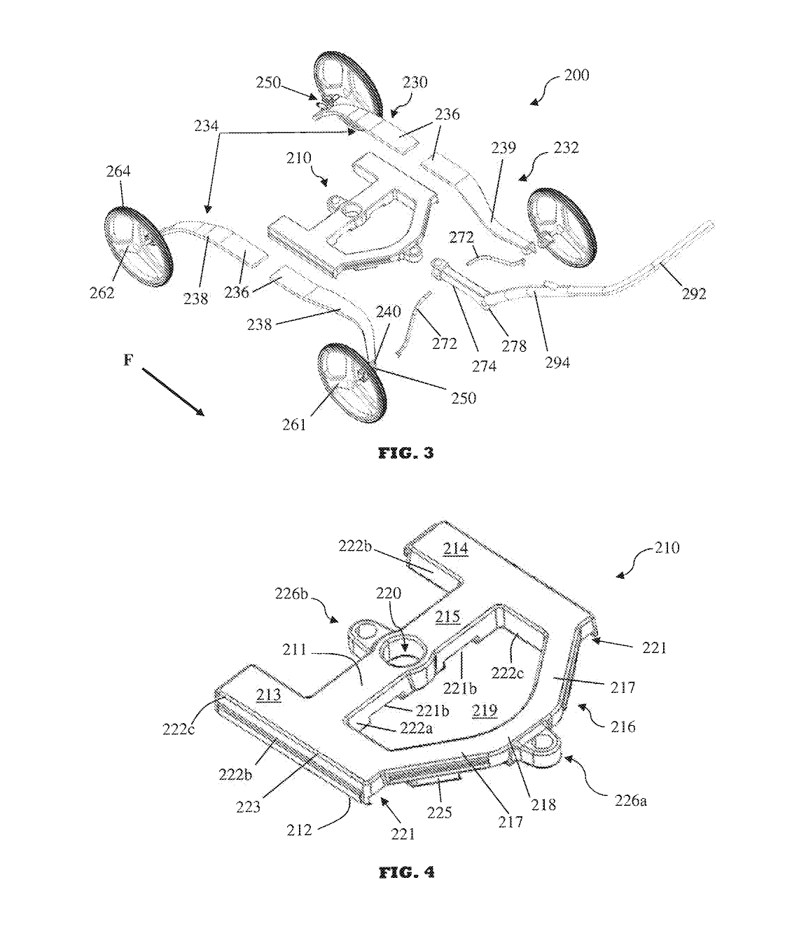

Referring now to FIGS. 2 and 3, an assembled exemplary universal chassis 200 and an exploded view of an exemplary universal chassis 200 are illustrated, respectively. Universal chassis 200 may include: a base 210, suspension arms 230, knuckle/hub assemblies 250, wheel/tire assemblies 260, a steering assembly 270, and a handle assembly 290. The base 210 provides the unique base structure for the universal chassis 200 and when the suspension arms 230, knuckle/hub assembly 250, wheel/tire assembly 260, steering assembly 270, and handle assembly 290 are connected with the base 210, the universal chassis 200 may be considered a rolling dynamic chassis (i.e., the chassis has a frame, the base 210, and the ability to mobilize via the other named assemblies).

Base 210 provides the central structural frame of universal chassis 200 that manages the ground/user interface and supports a compatible user module 300. As noted above, base 210 is the main mounting structure for the suspension and steering assemblies, handle assembly 290, and user modules 300. Base 210 is preferably composed of a light-weight material having a high strength-to-weight ratio, such as aluminum, an aluminum alloy, composites, plastics, carbon fibers, including carbon fiber-reinforced polymers and carbon fiber-reinforced thermoplastics, or a combination thereof. Additionally, base 210 may be made of either ferrous or non-ferrous materials, or a combination thereof.

Referring specifically to FIG. 4, an exemplary base 210 is shown generally in an “A” shape. It should be noted that base 210 may take other shapes, and that the base 210 shown in the figures is exemplary only. Base 210 may include opposed longitudinal members 213, 214, and a transverse member 215 that connects the opposed longitudinal members 213, 214. Transverse member 215 is shown substantially normal to opposed longitudinal members 213, 214. A bridge transverse member 216 also connects the opposed longitudinal members 213, 214 toward the front of base 210 (i.e., it forms the top portion of the “A” shape). In this embodiment, the bridge transverse member 216 is not perpendicular to the opposed longitudinal members 213, 214; rather, bridge transverse member 216 includes two angled portions 217 that generally project in a forward direction F from each opposed longitudinal member 213, 214. The angled portions 217 meet at bridge portion 218, which may be substantially parallel to transverse member 215. Additionally, the opposed longitudinal members 213, 214, the transverse member 215, and the bridge transverse member 216 may all comprise sidewalls 222 extending between the top 211 and bottom 212 of base 210. The intersection of the top 211 and each sidewall 222 of base 210 may have chamfered surfaces 223 for safety reasons, manufacturability, and may assist a user in aligning a user module 300 with universal chassis 200 during linking of the two structures. The opposed longitudinal members 213, 214, transverse member 215, and bridge transverse member 216 define an opening 219. Opening 219 may provide a place for an occupant user to place their feet when the user module 300 is a wagon, for example. Base 210 may also optionally include reflectors and/or lights 225 to facilitate visibility of universal chassis 200 for safe operation.

Bridge portion 218 may include a bridge joint 226a, which may be a revolute joint. Bridge joint 226a may be configured to receive a pin 276 that pivotably connects main bridge arm 274 to base 210. Main bridge arm 274 may in turn be coupled to steering assembly 270. Pin 276 may be secured in bridge joint 226a by means known to one skilled in the art, including the use of cotter, detent pins, or split pins, for example. Bridge joint 226a may include a damper to reduce and/or control thrust and vibrational loads experienced by a user through the handle assembly 290 when the modular transporter 100 is being pushed or pulled. A bushing or plain bearing (not shown) may be placed within the pin bore of bridge joint 226a to dampen the thrust and vibrational loads.

In the embodiment depicted in FIG. 2, the bridge joint 226a of universal chassis 200 is a revolute joint, which permits rotation about a single axis, which in the illustrated embodiment is a vertical axis Z. Accordingly, in the embodiment in FIG. 2, the main bridge arm 274 may only rotate laterally. However, bridge joint 226a may also be other types of joints known in the art, including a ball joint. If bridge joint 226a is a ball joint, the bridge joint 226a may be dampened by a dual rate bushing (not shown) to define a first resistance to lateral deflection, and a second resistance to vertical deflection. The second resistance to vertical deflection may be greater than the first resistance to lateral deflection, or vice versa, such that the bushing applies a differing resistance to vertical forces compared to lateral forces. A ball joint as bridge joint 226a may be desirable in situations where it is desired to remove handle assembly 290 and to attach main bridge arm 274 directly to a particular article, such as a tractor.

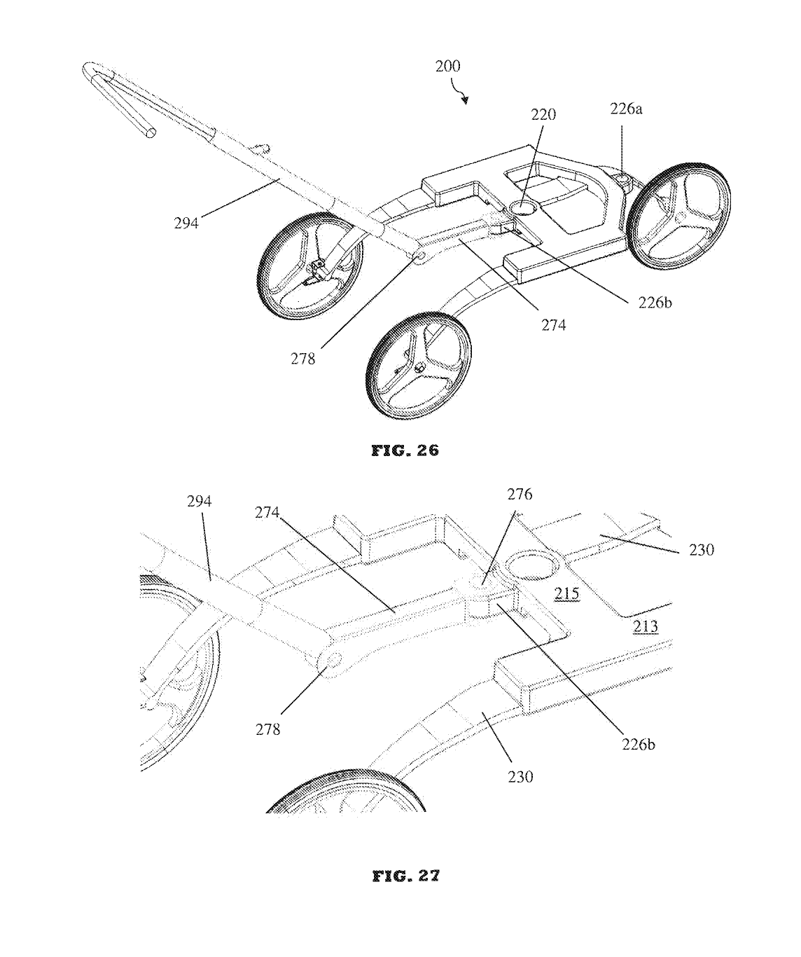

Referring now to FIGS. 26 and 27, universal chassis 200 may also be configured in a “push” three-wheeled transport configuration. A transverse joint 226b may be coupled to the transverse member 215 to permit the main bridge arm 274 to be pivotably connected thereto. Transverse joint 226b is structurally and functionally equivalent to bridge joint 226a, differing only in its location. A pin 276 may be fit through the pin boss of transverse joint 226b to secure the clevis portion of main bridge arm 274 in place. Securing means, such as cotter pins, split pins, or detent pins may be used to secure the pin 276 within the clevis portion of main bridge arm 274 and transverse joint 226b. Accordingly, when the handle assembly 290 is coupled to the transverse joint 226b, modular transporter 100 may be pushed in a desired direction.

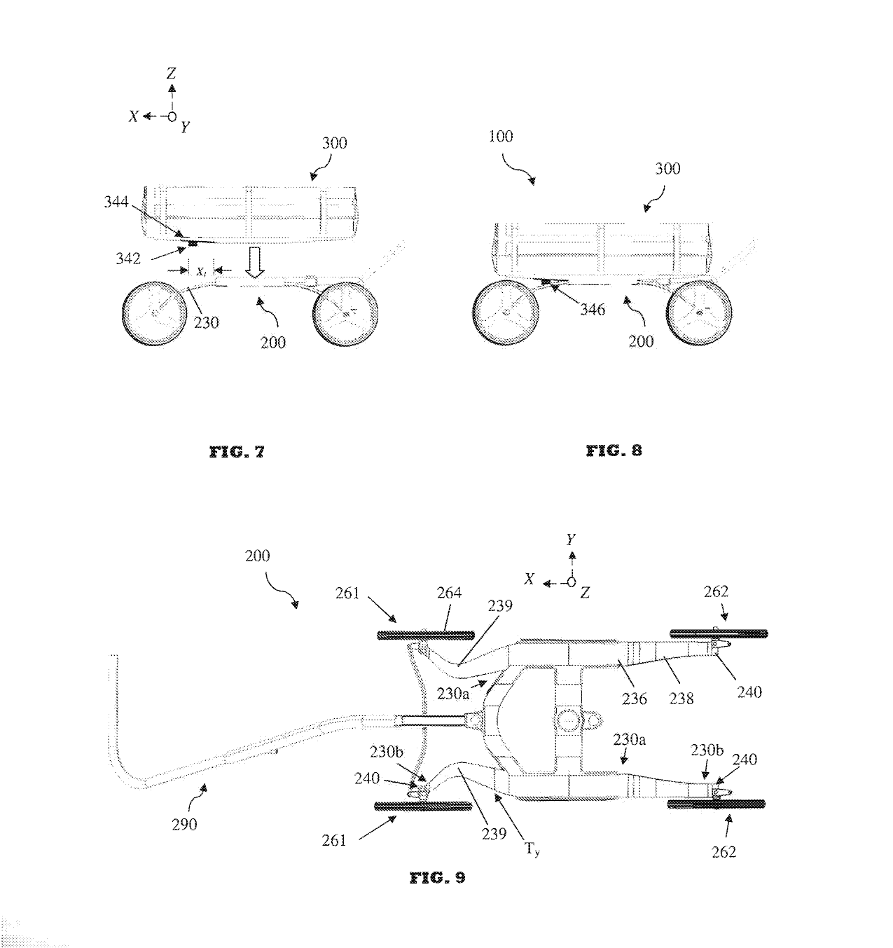

User modules 300 may be connected to base 210 in the following manner. A user first selects a particular user module 300 that fits his or her desired activity. Of course, user modules 300 may be designed for many different usage applications, but it is preferable that they have a common undercarriage 310 to connect with the universal or common architecture of base 210. FIG. 7 depicts an exemplary user module 300 being connected to an exemplary universal chassis 200, and FIG. 8 illustrates the user module 300 and universal chassis 200 of FIG. 7 fully connected to one another.

Referring now to FIGS. 5 and 6, to connect a user module 300 to base 210, base 210 may comprise a receiving quick connector 220 that allows a user module 300 to be quickly connected to (and disconnected from) the universal chassis 200. User module 300 may comprise a mating quick connector 320 that may be inserted into receiving quick connector 220 for secured engagement of the user module 300 to universal chassis 200. The mating of mating quick connector 320 with receiving quick connector 220 is the primary vertical locking mechanism that secures user module 300 to universal chassis 200. When there is only one quick connect, it is preferred that the receiving quick connector 220 be centrally located on base 210 to best counteract any vertical forces experienced by modular transporter 100. In the illustrated embodiments in FIGS. 5 and 6, the receiving quick connector 220 is located centrally on the transverse member 215 as it is shown in FIG. 4.

The mating quick connector 320 of user module 300 may comprise a shaft 330, which may be inserted into the receiving bore 228 of receiving quick connector 220. Shaft 330 and receiving bore 228 may both comprise tapered surfaces. It is preferred that receiving bore 228 is greater at its distal bore diameter 228a than its proximal bore diameter 228b, and that the proximal diameter 330a of shaft 330 is greater than its distal diameter 330b. In this manner, the distal diameter 330b of shaft 330 may be guided into the distal bore diameter 228a of receiving bore 228 for locating and alignment purposes. This ensures that user module 300 cannot be assembled in an incorrect attitude. As shaft 330 is inserted into the receiving bore 228, friction between the tapered bearing surfaces of the shaft 330 and receiving bore 228 act to clamp the user module 300 to base 210. To ensure that shaft 330 has been fully inserted into receiving bore 228 to a secure and failsafe location, the shaft 330 must be inserted past a sprung-loaded retaining pin (not shown). The sprung-loaded retaining pin may be released for simple disassembly.

To ensure that user module 300 cannot be oriented incorrectly on universal chassis 200, mating sealing surfaces 329 of mating quick connector 320 may have differing geometries proximate to the circumference of the proximal diameter 330a of shaft 330. As illustrated in FIGS. 5 and 6, mating sealing surfaces 329 may have a first mating sealing surface 329a having a first geometry and a second mating sealing surface 329b having a second geometry. The first and second mating sealing surfaces 329a, 329b, are configured to mate with receiving sealing surfaces 229, and more specifically, first mating sealing surface 329a is configured to mate with first receiving sealing surface 229a and second mating sealing surface 329b is configured to mate with second receiving sealing surface 229b as shown in FIG. 6. As the geometry of the sealing surfaces differ, first mating sealing surface 329a could not mate with second receiving sealing surface 229b. This would alert a user that user module 300 is not in the correct orientation, and that user module 300 must be adjusted such that the mating quick connector 320 can be connected to receiving quick connector 220.

In another embodiment, base 210 may include a plurality of receiving quick connectors 220 to accept a plurality of mating quick connectors 320 for engagement. This may be particular useful where modular transporter 100 may experience extreme vertical loads and the force necessary to counteract these vertical forces is great or the proximity and usage requirement of user module 300 dictates various quick connectors 220. In another embodiment, the mating quick connectors need not be confined to being located on a user module 300, and the receiving quick connectors need not be confined to being located on a base 210; the mating and receiving portions of the quick connectors may be on either the user module 300 or base 210.

As noted above, the engagement of the mating quick connector 320 with the receiving quick connects 220 securely connects user module 300 to universal chassis 200, and this connection acts to counteract vertical loads experienced by modular transporter 100. Modular transporter 100 may also experience fore/aft (longitudinal) and lateral loads. Longitudinal and lateral loads applied to modular transporter 100 may create a moment on user module 300 about a moment axis of universal chassis 200, which is a vertical axis Z in this case. In other words, these forces may tend to rotate user module 300 about a vertical axis Z of universal chassis 200. To counteract the moments caused by longitudinal and lateral forces about a moment center located on a vertical axis Z (i.e., the location of the quick connect), the internal sidewalls 222a and external sidewalls 222b of base 210 may have complex geometric surfaces that may be configured to receive geometrically complementary engagement surfaces 322 of user module 300. The complex geometric surfaces of sidewalls 222a and 222b may include inclined surfaces, curved surfaces, flat surfaces, or a combination thereof.

In one embodiment, the complex geometric surfaces of sidewalls 222a and 222b may include sidewall tapered surfaces 222c. When user module 300 is placed on base 210, the engagement surfaces 322 of a user module 300 grip the sidewall tapered surfaces 222c to further secure the user module 300 to universal chassis 200. The friction between these inclined tapered surfaces provides secure mounting of a user module 300 to base 210, and counteracts moments experienced by user module 300 about universal chassis 200. In other words, the tapered mating surfaces reduce the tendency of a user module 300 to rotate about a vertical axis Z of base 210. The draft angle of these tapered surfaces may be in the range of about one to five degrees.

The suspension arms 230 of universal chassis 200 will now herein be described in detail. Each suspension arm 230 may be the sole suspension link between base 210 and each wheel/tire assembly 260. Accordingly, each suspension arm 230 must counteract vertical, fore/aft, and lateral loads experienced by the tire/wheel assemblies 260. As will be described in greater detail herein, the geometries and non-linear spring constants of each suspension arm 230 allows the suspension system to handle the noted forces. Hence, suspension arms 230 of universal chassis 200 offer variable ride control under a wide range of cargo loads and ride height configurations, and are engineered for optimal kinematics and compliances to provide modular transporter 100 with safe/predictable/responsive handling dynamics. As a result, modular transporter 100 facilitates a more controlled and flatter ride for its cargo content.

Referring again to FIGS. 2 and 3, universal chassis 200 is shown comprising suspension arms 230. In the illustrated embodiments, universal chassis 200 is configured with four individual suspension arms 230 not linked to one another, making the universal chassis 200 an independent suspension system (i.e., wheels 261, 262 may move vertically independently of one another). In other configurations, such as a three-wheeled or two-wheeled transport configuration, universal chassis 200 may also be an independent suspension system, as suspension arms 230 may be connected to base 210 independently of one another, and are not linked by a shared axle. Universal chassis 200 may include a plurality of front suspension arms 232 and a plurality of rear suspension arms 234, and in some embodiments, front and/or rear suspension arms may be omitted depending upon the desired transport configuration. In this manner, suspension arms 230 may be removeably connectable with the base 210.

Suspension arms 230 may be of a composite material or other light-weight materials. Preferably, a composite material having a high strength-to-weight ratio is selected. To account for widely varying loads that may be experienced by modular transporter 100, suspension arms 230 may be comprised of composite materials having varying spring constants (similar to a leaf spring). This allows suspension arms 230 to stiffen automatically when a heavy vertical load is applied to modular transporter 100.

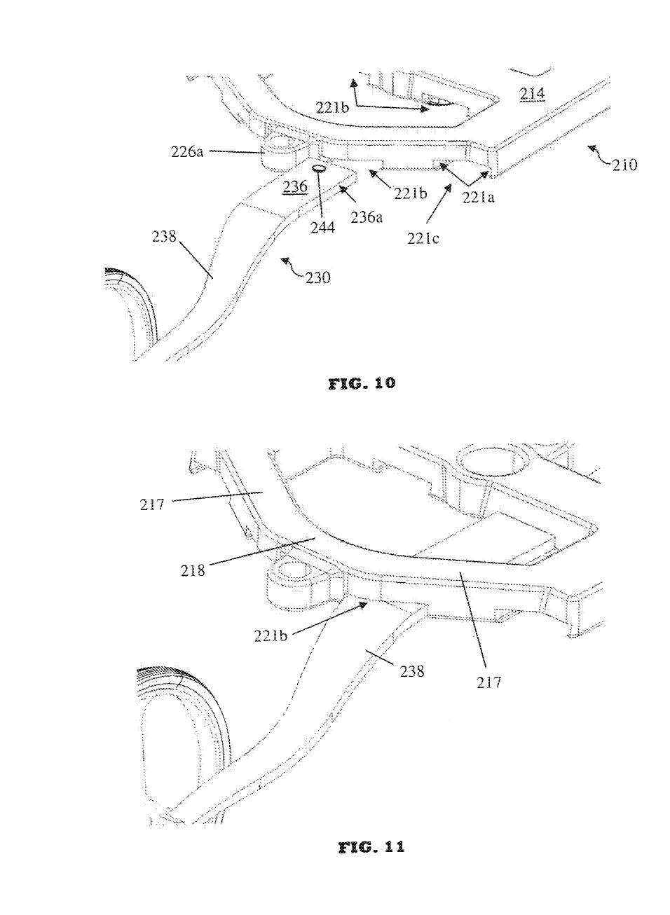

In one embodiment, each suspension arm comprises a connecting portion 236, a curved portion 238, and a wheel coupling portion 240. Connecting portions 236 of suspension arms 230 may attach to base 210, and may be slid in and out of slots 221 for assembly/disassembly (i.e., the suspension arms 230 are removeably connectable with base 210). The connecting portions 236 of suspension arms 230 may have mating securing mechanisms 236a that mate with receiving securing mechanisms 221a located within slots 221 of base 210. The engagement of the mating and receiving securing mechanisms secure and restrain the suspension arms 230 from moving about the six named degrees of freedom. FIGS. 10 and 11 more clearly show exemplary mating and receiving securing mechanisms. In the illustrative embodiments of FIGS. 10 and 11, the mating and receiving securing mechanisms are male and female portions of a dovetailed configuration. Other mating configurations are possible so long as the mating of the connecting portions 236 and slots 221 are made securely. To further secure the suspension arms 230 into slots 221, suspension arms 230 may be pushed past a sprung-loaded retaining pin 244 that mates with a recessed hole (not shown) in slot 221 of base 210. For disassembly, the sprung-loaded retaining pins 244 may be quickly released, and the suspension arms 230 may be removed from their corresponding slots 221. Base 210 may include inboard slots 221b and outboard slots 221c. Suspension arms 230 may be inserted into inboard slots 221b when it is desired to configure universal chassis 200 in a three-wheeled configuration, for example. In FIGS. 10 and 11, a suspension arm 230 is shown being aligned and secured by the inboard slot 221b located on angled portion 217 of base 210 and fully secured into the inboard slot 221b of the transverse member 215. A sprung-loaded retaining pin 244 may further secure the suspension arm 230 into slot 221b of the inboard slot 221b of the transverse member 215. When desired to configure universal chassis 200 in a four-wheeled transport configuration, suspension arms 230 may be inserted into outboard slots 221c as shown in FIG. 2.

Referring to FIG. 9, the curved portions 238 of each suspension arm 230 generally connect to the connecting portion 236 at an arm proximal portion 230a of each suspension arm 230 and to a wheel coupling portion 240 at an arm distal portion 230b of each suspension arm 230. Curved portion 238 allows dynamic clearance to each wheel assembly 260.

Referring still to FIG. 9, the geometries of the front rear suspension arms 232 and rear suspension arms 234 will now be described. In the bottom view of the four-wheeled configuration of universal chassis 200 in FIG. 9, the front wheels 261 are steered wheels and the rear wheels 262 are non-steered wheels. In this embodiment, because the front wheels 261 are steered wheels, front suspension arms 232 must allow for front wheels 261 to rotate when steered. Accordingly, front suspension arms 232 may have inboard curved portions 239 that provide clearance for front wheels 261 to be steered. As rear wheels 262 are non-steered wheels, inboard curved portions 239 on suspension arms 230 are not necessary. However, rear suspension arms 234 may optionally include inboard curved portions 239 regardless of whether the rear wheels 262 are steered or non-steered wheels. In a three-wheeled configuration, the curvature of the inboard curved portion 239 of the front suspension arm 234 allows the front wheel 261 to coaxially align with the fore/aft axis X of universal chassis 200, as shown in FIG. 14.

Both front suspension arms 232 and rear suspension arms 234 are illustrated having thicker lateral thicknesses T_{y} (or depth) at their arm proximal portions 230a than at their arm distal portions 230b. In the case of the front suspension arms 232, the lateral thickness T_{y} of suspension arms 230 narrows gradually from the connecting portion 236 to the wheel coupling portion 240. In the case of the rear suspension arms 234, the lateral thickness T_{y} of the suspension arms 230 narrows gradually along the length of the arm up until a point, but then the lateral thickness T_{y} becomes relatively consistent to the end of arm distal portions 230b.

In this embodiment, each suspension arm 230 is the sole suspension link between the base 210 and the wheel/tire assemblies 260, and thus, they must support and counteract translational vertical, fore/aft, and lateral loads, as well as rotational forces about the vertical axis Z, fore/aft axis X, and lateral axis Y. Each suspension arm 230 is designed to counteract all six degrees of freedom.

As each suspension arm 230 is the primary member that counteracts lateral forces experienced by the wheel/tire assemblies 260, the lateral thickness T_{y} must be selected to properly counteract these loads. The lateral thickness T_{y} controls the spring rate lateral compliance, and accordingly, the lateral thickness T_{y} must be thick enough to allow the tires 264 to maintain a sufficient Tire Contact Patch (TCP), or contact interface between the ground and tires 264, when lateral forces are experienced. The lateral thickness T_{y} may be selected in the range of 25 mm (≈1 inch) to about 125 mm (≈5 inches).

Each suspension arm 230 is also the primary member that counteracts vertical forces experienced by the wheel/tire assemblies 260. The vertical thickness T_{z} controls the spring rate vertical compliance of the suspension system, and thus the vertical thickness T_{z} (FIG. 5) must be thick enough such that suspension arms 230 provide the proper stiffness to maintain a sufficient Tire Contact Patch TCP when vertical loads are experienced. The vertical thickness T_{z} may be selected in the range of 10 mm 0.4 inches) to about 100 mm 4 inches). The fore/aft length and vertical thickness T_{z} of each suspension arm 230 controls the fore/aft compliance of the suspension system, and thus must be selected to counteract fore/aft loads. In summary, the position (or Tire Contact Patch TCP) of the tire/wheel assemblies 260 is controlled in all six degrees of freedom by suspension arms 230.

Referring again to FIGS. 7 and 8, a bump stop 342 is shown on the undercarriage 310 of user module 300. A plurality of bump stops 342 may be included on user module 300, although only one is shown in the figures. Bump stop 242 may be rubber or other naturally dampening material, such as a gel, and may include an internal damper, such as a spring (not shown) to further improve the transporter device's 100 ride experience and control the sprung mass. Bump stop 342 is positioned such that when a load is placed on or in user module 300, the bump stop 342 engages a suspension arm 230 at a bump stop engagement position 346. Bump stops 342 prevent the user module 300 from slamming down on the suspension arms 230 when modular transporter 100 experiences a shock load, or more generally when a heavy load is applied to user module 300. Bump stops 342 also have the effect of changing the variability of the spring rate (i.e., the stiffness) of the suspension arms 230.

Each bump stop 342 may be adjustable along a fore/aft axis X of the undercarriage 310 of a user module 300. For example, a bump stop 342 may be adjustable along a track 344. Adjusting bump stop 342 along the fore/aft axis X a distance X₁ changes the variability of the spring rate of the suspension arms 230.

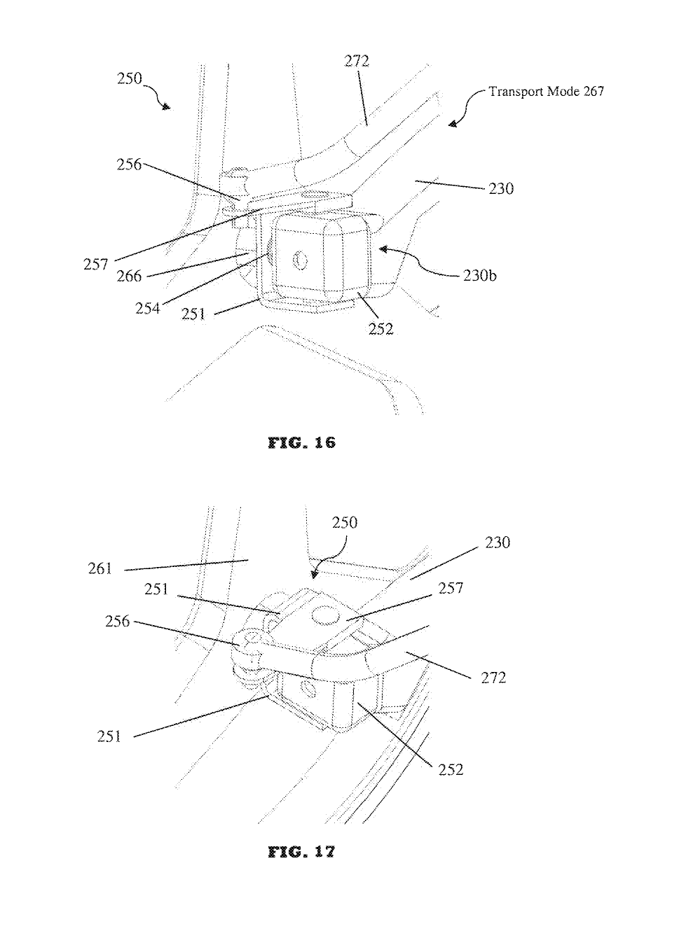

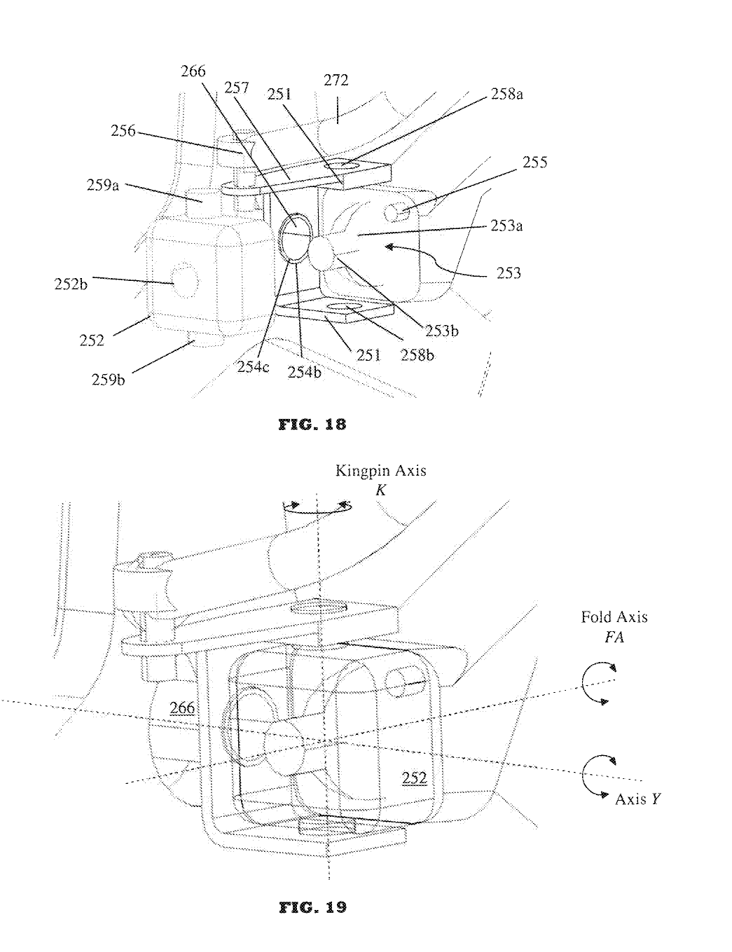

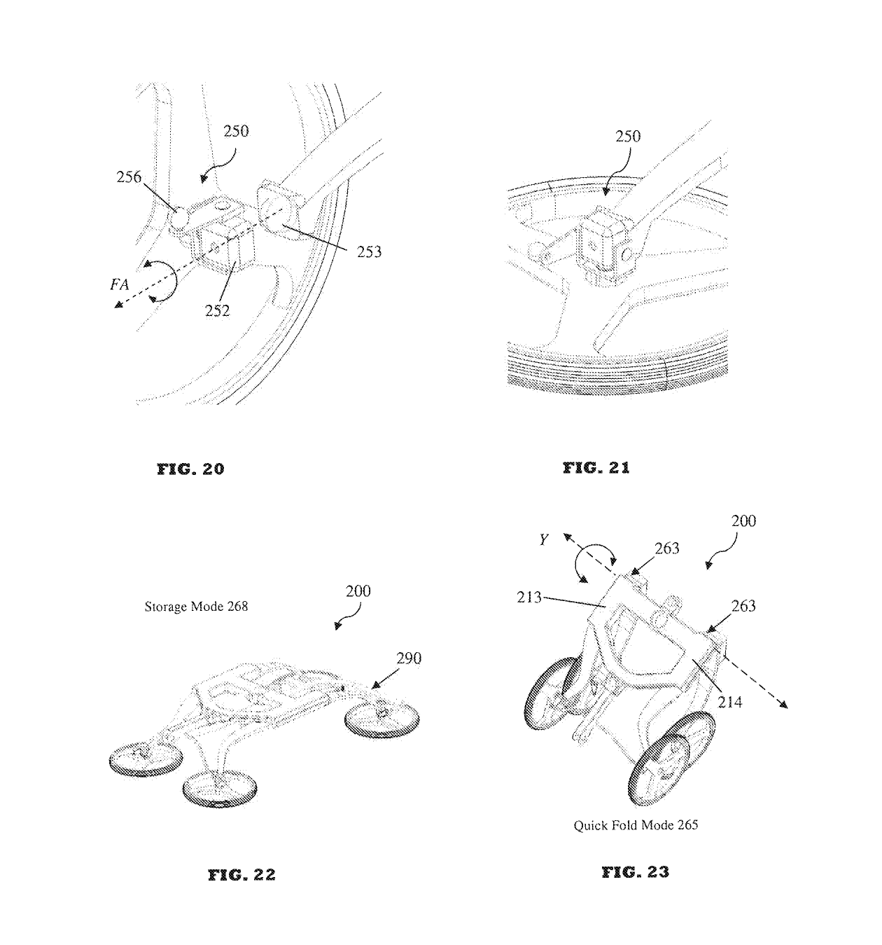

Referring generally to FIGS. 16-22, universal chassis 200 may comprise knuckle/hub assemblies 250 that couple suspension arms 230 with the wheel/tire assemblies 260. Each knuckle/hub assembly 250 may be used for either steered wheels or non-steered wheels. The knuckle/hub assemblies 250 also allow for each wheel/tire assembly 260 to be folded flat such that universal chassis 200 is configured in a storage mode 268 as shown in FIG. 22. As illustrated in FIG. 22, all of the wheel/tire assemblies 260 may be positioned flat relative to the ground to decrease the elevation silhouette of universal chassis 200. Of course, to further decrease the elevation silhouette of universal chassis 200, suspension arms 230 can be removed from base 210.

Suspension arms 230 may connect with the knuckle/hub assemblies 250 in the following exemplary manner. Generally, the arm distal portion 230b of each suspension arm 230 connects with receiving cup 252. The arm distal portion 230b may comprise a ball joint 253 at its end that has a spherical portion 253a and a shaft portion 253b that protrudes out from the spherical portion 253a. Spherical portion 253a provides a relatively large bearing surface to stabilize the joint or interconnection of the suspension arm 230 to the knuckle/hub assembly 250. The shaft portion 253b may be inserted into a receiving bore 252b of receiving cup 252. The receiving bore 252b may include a bushing or bearing (not shown) lining the circumference of the bore to facilitate rotation of the shaft portion 253b about the centerline of the receiving bore 252b. Shaft portion 253b acts as an aligning feature, and also facilitates rotation of the knuckle/hub assembly 250 about fold axis FA, which may be coaxial with fore/aft axis X (FIG. 19). A spring-loaded release pin 255 locks the suspension arm 230 in place with the receiving cup 252, and may be disengaged quickly for disassembly of the suspension arm 230 from the receiving cup 252 via a button, detent, or other mechanism.

Receiving cup 252 has pivot points 258a, 258b that may accept kingpins 259a, 259b. Kingpin 259a secures steering arm 257 and knuckle 251 to the receiving cup 252. Kingpin 259b secures the bottom portion of knuckle 251 to receiving cup 252. Kingpins 259a, 259b allow knuckle 251 to rotate about a kingpin axis K when the wheel/tire assemblies 260 are steered (FIG. 19). Kingpin axis K may be slightly inclined relative to a true vertical axis Z at a kingpin inclination angle, as is commonly known in the art. To drive or rotate knuckle 251 about the kingpin axis K, a user may laterally articulate the handle assembly 290, which in turn causes the main bridge arm 274 to drive steering links 272 in a particular direction, which in turn causes the steering links 272 to drive steering arms 257 about ball joints 256, which causes the steering arm 257 to rotate the knuckle 251 about kingpin axis K, moving the wheel/tire assemblies 260 in the desired direction.

Hubs 254 may attach to knuckles 251. Each hub 254 may comprise a fixed portion 254a and a rotatable portion 254b, or simply a rotatable portion 254b if a fixed portion 254a is not desired. A fixed portion 254a may include an attachment point for a braking assembly (not shown), or other stationary parts such as a stator of an encoder sensor (not shown). The braking assembly may be configured to operably function in synchronization with a given user module 300. For example, if a user module 300 is a child bike trailer carrier and the universal chassis 200 is in a two-wheeled, tow configuration as shown in FIG. 15, and the modular transporter 100 is connected to a bike, the braking assembly can be configured to brake in synchronization with the brakes of the bike. Likewise an encoder sensor may provide speed and mileage feedback to a jogger and display the feedback via a user control center 298.

The rotatable portion 254b of hub 254 may be coupled to a spindle or axle 266 that may in turn be coupled to wheels 261, 262. Rotatable portion 254b of hub 254 may include a bearing 254e that may provide an interface between the knuckle 251, hub 254, and axle 266. In this manner, hubs 254 are rotatably supported by knuckles 251 for rotation about axis Y, allowing wheels 261, 262 to rotate. Rotatable portion 254b may also include a rotor (the rotary part of an encoder sensor) for feedback to a user, as noted above. The hub 254/wheel 261 and 262 interface may be configured in either a positive or negative/neutral camber relative to a true vertical axis Z. A static negative camber of the wheels 261/262 may be useful for off road or higher speed applications, as a negative camber can offer more stability through a more efficient Tire Contact Patch TCP. Furthermore, the knuckle hub assemblies 250 may be modified to adjust the static camber, caster and toe as required by the user to suit his or her dynamic requirements.

The knuckle/hub assemblies 250 may be folded flat relative to the ground in the following manner. First, assuming the knuckle/hub assembly 250 is fully assembled, steering links 272 are removed from their respective ball joints 256. If folding a non-steered wheel flat, this first step may be omitted as there is no steering link 272 to remove. Second, assuming universal chassis 200 is in a four-wheeled transport configuration and with reference to the front, left wheel from a front view perspective, the front left wheel 261 may be rotated about fold axis FA in a CCW direction to move it from a transport mode 267 to storage mode 268. The left wheels (both front and back) will both need to be rotated in a CW direction to move the wheels from a storage mode 268 to a transport mode 267. The right, front wheel 261, with reference from a front view of universal chassis 200, may be rotated about a fold axis FA in a CW direction to fold the wheel flat relative to the ground. From a front view perspective, the right wheels (both front and back) will be rotated in a CW direction to fold the wheels flat. The right wheels will be rotated in a CCW direction move the wheels from a storage mode 268 to a transport mode 267. As the wheels 261, 262 are rotated, shaft portion 253b facilitates rotation of the knuckle/hub assembly 250.

In another embodiment, universal chassis 200 may be folded into a quick fold mode 265, as shown in FIG. 23. Opposed longitudinal members 213, 214 may include base hinges 263 that allow for base 210 to be folded into quick fold mode 265. Base hinges 263 may generally be coaxial with lateral axis Y, and thus, universal chassis 200 may fold along lateral axis Y as shown in FIG. 23. Folding universal chassis 200 into quick fold mode 265 reduces its fore/aft profile, thus making it easier to stow in spaces with limited fore/aft areas. When the universal chassis 200 is in transport mode 267, a lock bar or other securing mechanism may optionally be included to further stabilize the base hinges 263 and prevent universal chassis 200 from inadvertently folding into quick fold mode 265. In this embodiment, rear suspension arms 234 may be permanently attached to base 210, or alternatively, rear suspension arms 234 may have connecting portions 236 having mating securing mechanisms 236a that are configured to mate with receiving securing mechanisms 221a of slots 221.

Wheel/tire assembly 260 includes wheels 261, 262 and tires 264. Wheel/tire assemblies 260 are preferably a lightweight assembly to reduce the unsprung mass of the suspension system. The wheel/tire assembly 260 is optimized for dynamic performance on a wide range of surfaces, as the suspension system is configurable as an independent suspension system. Although the wheel/tire assembly 260 is illustrated in the various figures as including wheels 261, 262 and tires 264, these items may be interchangeable with other ground/chassis interface components, such as skis to be used in winter conditions, hydrofoils or pontoons (floats) for use in water applications, or even tracked wheels for desert or rough terrain applications. “Wheels” will be used for exemplary purposes and in the appended claims, but it must be noted that “wheels” may be substituted with and is interchangeable with any ground/chassis interface component.

In another embodiment, front wheels 261 and rear wheels 262 may be caster wheel assemblies 269. In this embodiment, steering links 272 are not required, as the caster wheel assemblies 269 may be configured to swivel when handle assembly 290 is pushed, pulled, et cetera in a given direction. In this embodiment, the knuckle/hub assemblies 250 would be slightly modified are coupled with modified knuckle/hub assemblies 250. The modified knuckle/hub assemblies 250 are different in the sense that caster wheel assemblies 269 may have a vertical mounting pin angled along the king pin axis K.

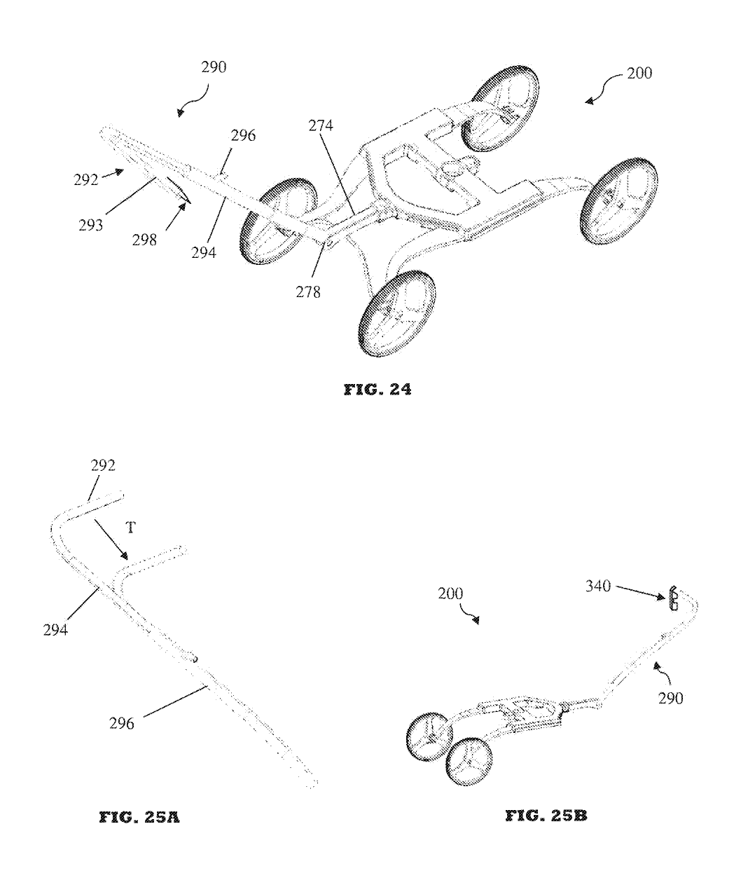

Referring now to FIGS. 24, 25A, and 25B, an adjustable ergonomic handle assembly 290 is shown comprising a handle 292, handle arm 294, and a camera 296. A user may utilize the handle 292 to push, pull, tow, or carry modular transporter 100. The handle 292 is flexible and may be made of a composite, aluminum, or other light-weight material. The handle 292 may comprise a grip 293 that may be made of a soft rubber compound or foam, for example. The handle 292 may be adjusted to a height desired by a user by moving the handle in or out of the handle arm 294 telescopically and rotationally at joint 278 between the handle arm 294 and main bridge arm 274. Handle assembly 290 is thus versatile in that in can accommodate the ergonomic requirements of users for many percentiles. FIG. 25A illustrates the handle 292 being moved telescopically further downward into the handle arm 294 to adjust the height of handle 292, which is shown by the direction arrow T. Handle 292 can be extended the opposite direction of T for a taller user or to create an appropriate distance between modular transporter 100 and a bike, for example. The handle 292 may be locked in or disengaged from a particular position by mechanical methods known in the art.

Handle assembly 290 may be adjusted to fold underneath universal chassis 200 when the chassis is in storage mode 268, as shown in FIG. 22, with the handle 292 protruding out laterally to the side of universal chassis 200. In this exemplary carry transport configuration, a user is able to grab hold of the handle 292 and carry the universal chassis 200. Handle assembly 290 may also comprise an application adapter 340 that links with handle assembly 290. For example, an application adapter 340 may include a bike hitching device that links the handle assembly 290 with a bike. FIG. 25B illustrates an application adapter 340 attached to handle assembly 290 that in turn could be connected to a bike hub or other location.

Handle arm 294 may include a camera 296 that allows a user to make safe observations of the cargo content of user module 300 without the need to turn their head/body around. This application may be particular useful if the selected usage application is a jogging stroller, a child pulled wagon or a bike trailer user module 300, as the speed of the modular transport 100 may be significant and the user may not be able to safely look back into the cargo area. Additionally, handle 292 may include a user control center 298 (e.g., an onboard touch-screen instrument panel) that may allow a user to connect with various product features, such as adjustment of the lights 225, connection with other devices via Bluetooth®, screen shots from camera 296, a user's vitals monitored during exercise, et cetera.

In another embodiment, modular transporter 100 may be an autonomous transporter 600. Autonomous transporter 600 may comprise an autonomous universal chassis 602 that may link with a wide range of user modules 300. Autonomous universal chassis 602 may also be configurable in many different transport configurations, such as a two, three, or four-wheeled transport configuration. Autonomous transporter 600 may be used in a number of situations. For example, autonomous transporter 600 could be linked with a user module 300 comprising a water tank and sprinkler mechanism. The autonomous transporter 600 may be instructed to water or fertilize certain areas of a yard. Once finished, the autonomous transporter 600 could then be programmed to open the garage door, and store itself away. Autonomous transporter 600 could also be used as a “guard” or “watch” dog. For example, if a user has value items or crops on his or her land and needs a watchful eye over the valuable items, autonomous transporter 600 could be equipped with a user module 300 having a camera and sensors to monitor the valuable items. The versatility of autonomous transporter 600 (and likewise modular transporter 100) is seemingly endless; autonomous transporter 600 can be used as a child bike trailer carrier during the day and used as a watch dog at night.

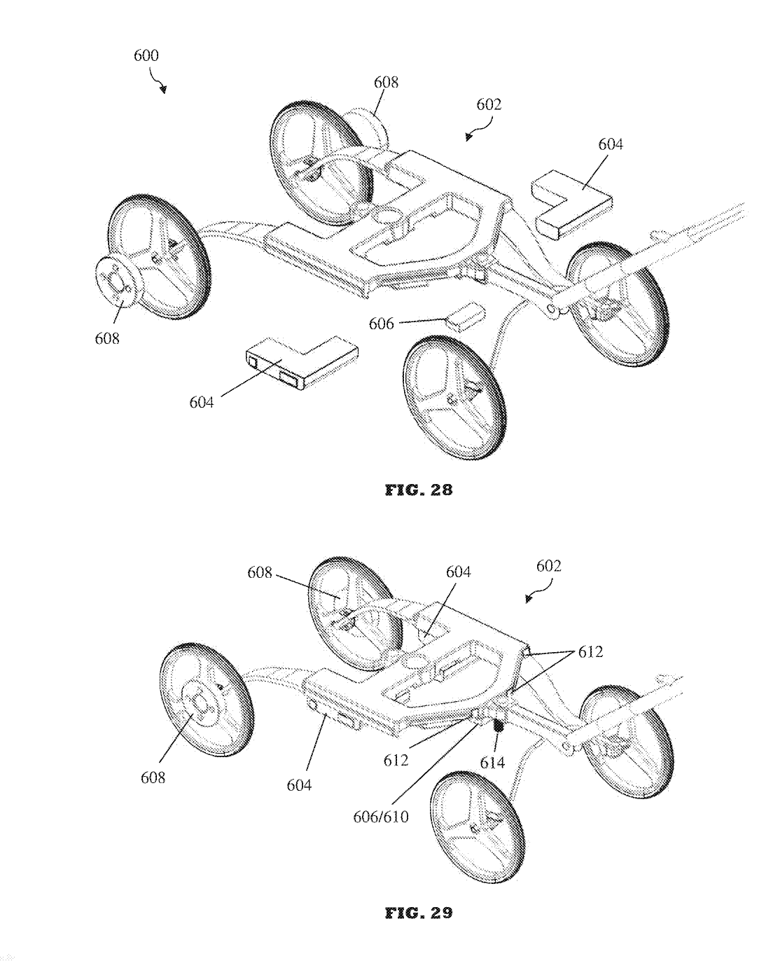

Referring now to FIGS. 28 and 29, an autonomous universal chassis 602 is shown in an exploded view and in an assembled view, respectively. A power source 604, such as lithium ion battery packs or capacitors, may be coupled with the bottom 212 of base 210, or may be mounted to other locations on base 210, and may provide the energy required by propulsion devices 608 to drive autonomous transporter 600. Propulsion devices 608 may be in-wheel hub motors with regenerative braking capabilities, for example. Propulsion devices 608 may be coupled to the wheel/tire assemblies 260 of universal chassis 200, and configured to drive the axles 266 of wheel/tire assemblies 260 about axis Y in order to generate the force required to move autonomous transporter 600.

Power sources 604 may be in communication with a controller module 606 that operates to regulate the flow of energy to and from propulsion devices 608. Controller module 606 may be located on the bottom 212 of base 210, or in other locations. Where propulsion devices 608 are in-wheel hub motors with regenerative braking, an inverter (not shown) may commutate the flow of current depending on whether autonomous transporter 600 is accelerating or decelerating via braking. This allows energy that is typically wasted to be recovered and stored in power sources 604. Where propulsion devices 608 are without regenerative braking capabilities, an inverter may also be included in the electric circuitry to change the current from a direct current (DC) power source 604 to propulsion devices 608 designed to run on alternating current (AC).

An autonomous steering controller 610 may also be attached to autonomous universal chassis 602 to control the steering movements of autonomous transporter 600. The autonomous steering controller 610 may be located or embedded with controller module 606, or may be separate hardware. Autonomous steering controller 610 may include a microprocessor, and various non-transitory memory modules, such as read-only memory, flash memory, and optical memory, for example. Autonomous steering controller 610 may also include random access memory, among other common transitory-type computer readable mediums known in the art. It should be noted that controller module 606 may include similar non-transitory and transitory computer readable mediums found in autonomous steering controller 610. Various sensors (e.g., Radar, Laser range, LIDARS, et cetera) and autonomous camera 612 in conjunction with GPS may be used to view/map the environment of autonomous transporter 600. The sensor systems may send feedback to the controller module 606 and autonomous steering controller 610 such that autonomous transporter 600 may be appropriately steered, braked, propelled, et cetera. Autonomous camera 612 may include a plurality of cameras to capture the environment. Based on the feedback provided by autonomous camera 612, an autonomous actuator 614 may be operably coupled to steering assembly 270 to steer front wheels 261. That is, based on input from the autonomous steering controller 610 and controller module 606, the autonomous actuator 614 may drive the main bridge arm 274, which in turn causes the steering links 272 to steer the wheel/tire assemblies 260 in a given direction. FIG. 29 illustrates autonomous universal chassis 602 in a steering linkage controlled configuration.

Alternatively, differential steering may be provided by two independent rear propulsion devices 608 (e.g., in-wheel hub motors) applying different torques causing a steered effect. In this embodiment, the front wheels 261 could be caster wheel assemblies 269, and they could simply track straight ahead after the rear wheels 262 configured with propulsion devices 608 had created the steer. The rear propulsion devices 608 could provide equal motive power to move autonomous transporter 600 forward in straight line, or if a turn is desired, the propulsion devices 608 would apply differing torques to complete the steering command.

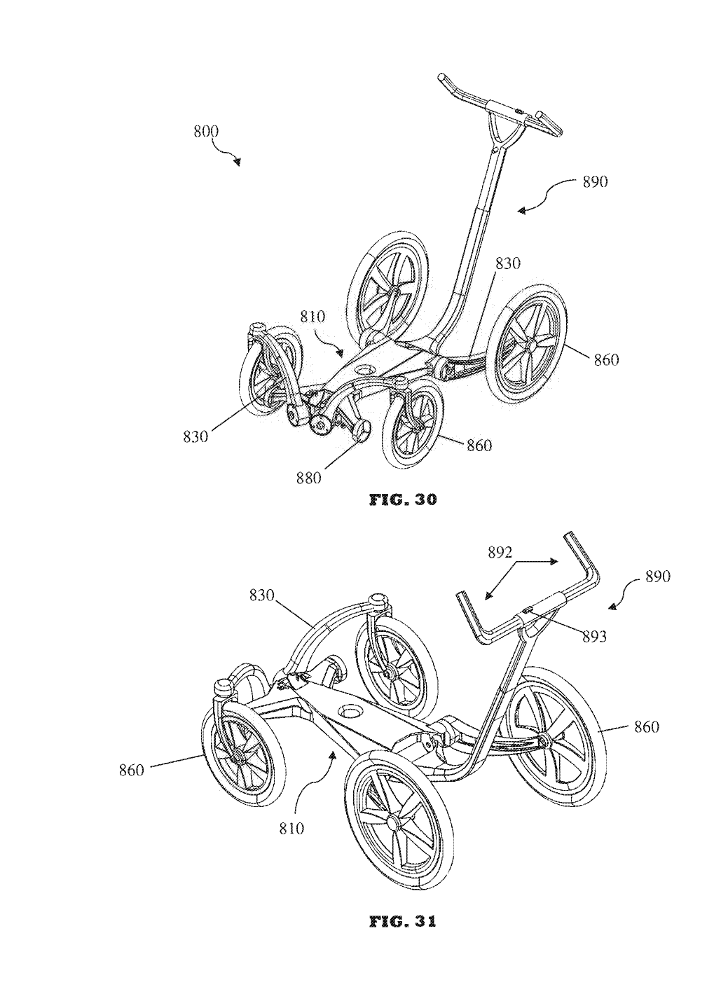

With reference now to FIGS. 30-49, another exemplary embodiment of a universal chassis 800 is shown. In this embodiment, universal chassis 800 may comprise a base 810, a number of suspension arms 830, wheel/tire assemblies 860, and a handle assembly 890.

Base 810 may provide a universal structural frame that may be configured to link with a number of different user modules 300. Base 810 may have a top 811 and bottom 812, and side walls 822 extending therebetween. The side walls 822 of base 810 may comprise complex geometric surfaces. The complex geometric surfaces of the side walls 822 may be, for example, tapered, angled, rounded, curved, chamfered or a combination thereof. Side walls 822 may be complementary with the engagement surfaces 322 of a user module 300. Base 810 may further comprise of a plurality of receiving quick connects 820 that may be configured to receive and/or mate with a corresponding quick connect 320 of a user module 300. Alternatively, base 810 may have a mating quick connect and user module 300 may have a receiving quick connect. The quick connect 820 and side walls 822 of base 810 may permit a secure mounting connection of a user module 300 with universal chassis 800 when a user module 300 is mounted thereto. A user module 300 may be mounted to base 810 in the same manner as shown in FIGS. 5 and 6 and described in the accompanying text.

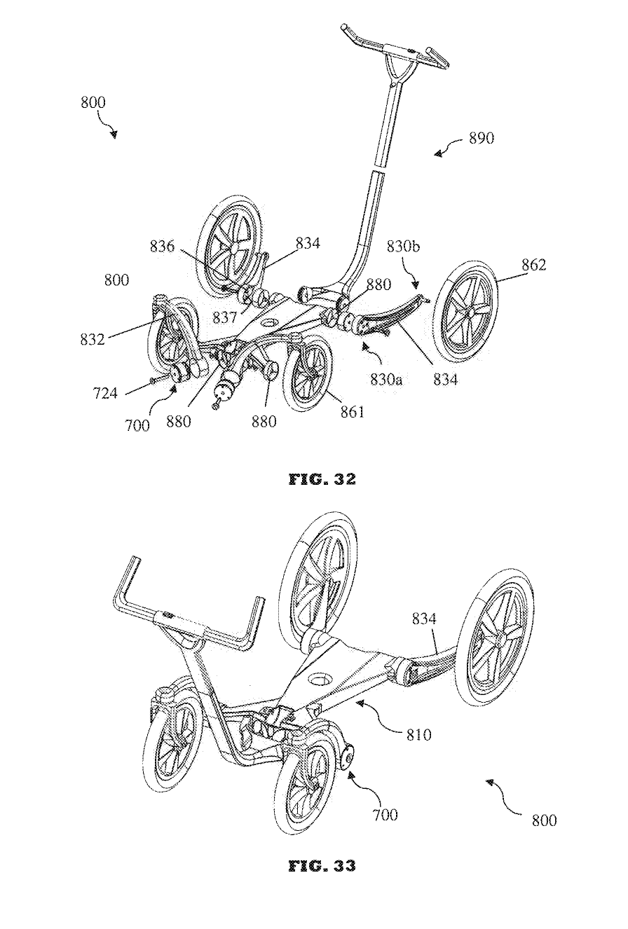

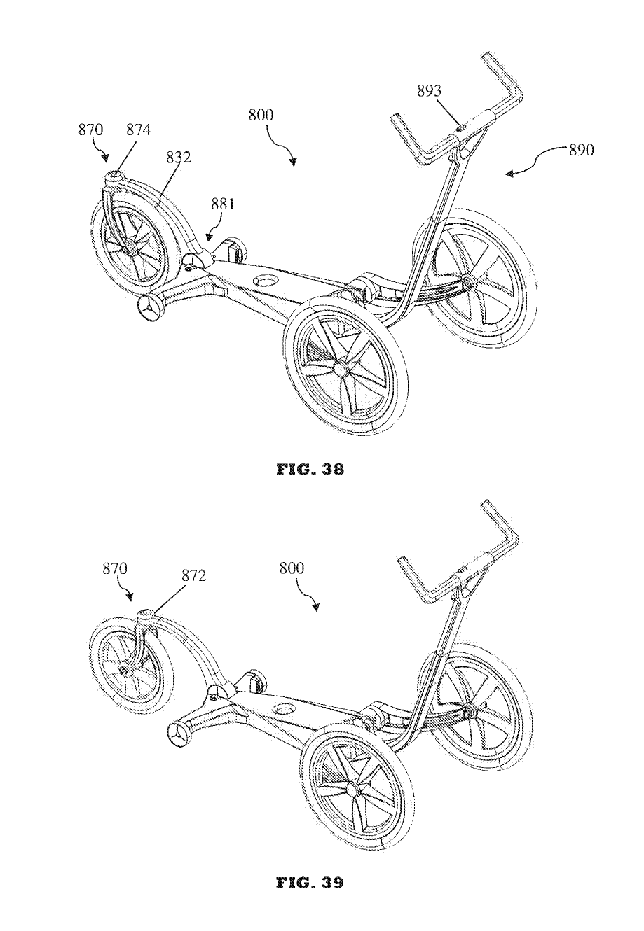

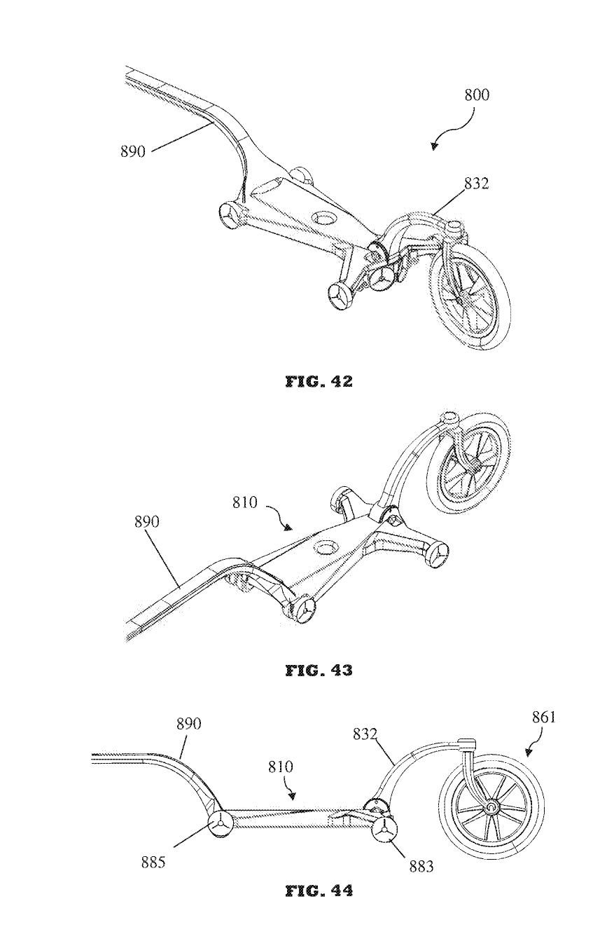

A number of suspension arms 830 may each be removeably connectable with base 810, allowing the universal chassis 800 to be configured in a number of different transport configurations, including a one (FIG. 42), two (FIG. 41), three (FIG. 38), or four-wheeled (FIG. 30) transport configuration. Base 810 may have a plurality of spring unit seats 880 that may each be configured to receive a spring unit 700 (spring units 700 will be described in greater detail later in the disclosure). Spring units 700 may allow for suspension arms 830 to be readily connected to or removed from base 810, and act to dampen, absorb, and counteract forces applied to modular transporter 100. An axle pin 724 may be inserted into a pin bore 716 of a given spring unit 700 to secure the spring unit 700 and suspension arm 830 to base 810. An axle pin 724 may be inserted through a suspension arm 830 and spring unit 700 as shown in FIGS. 32 and 35 for the rear suspension arms 834, or alternatively, axle pin 724 may be inserted directly through spring unit 700 and secured in the spring unit seat 880 to couple a front suspension arm 832 to base 810, as shown in FIGS. 32 and 35.

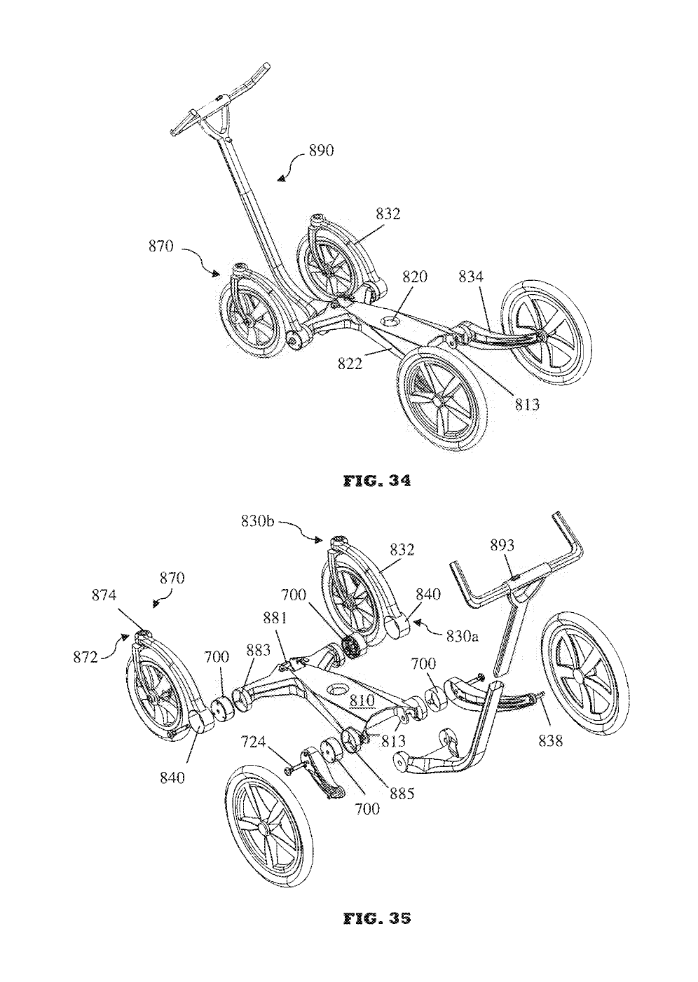

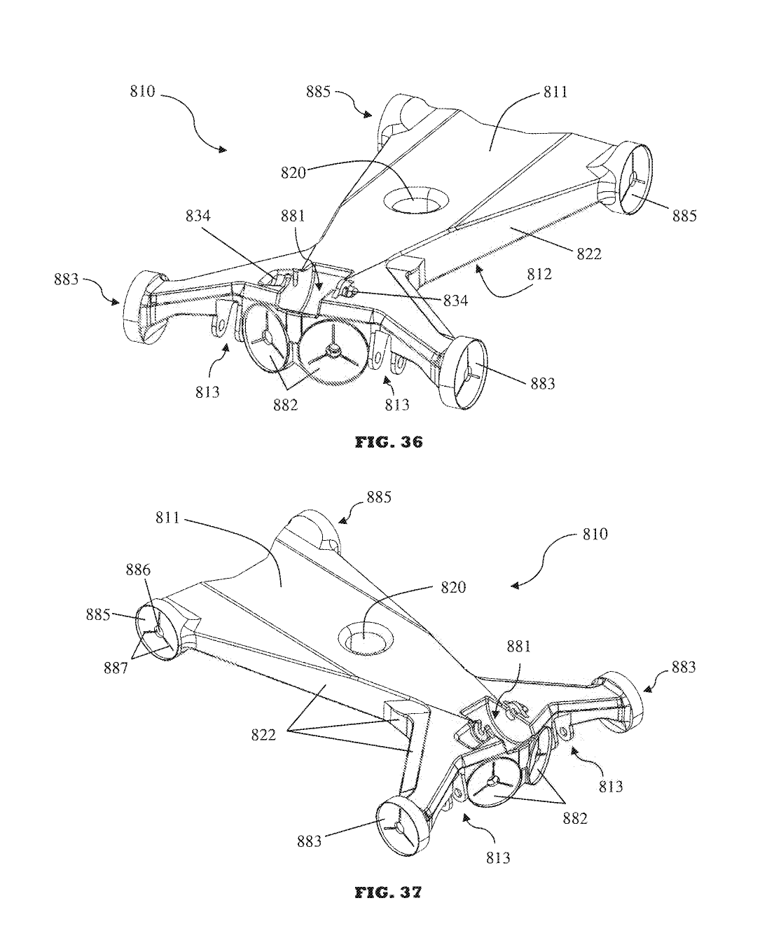

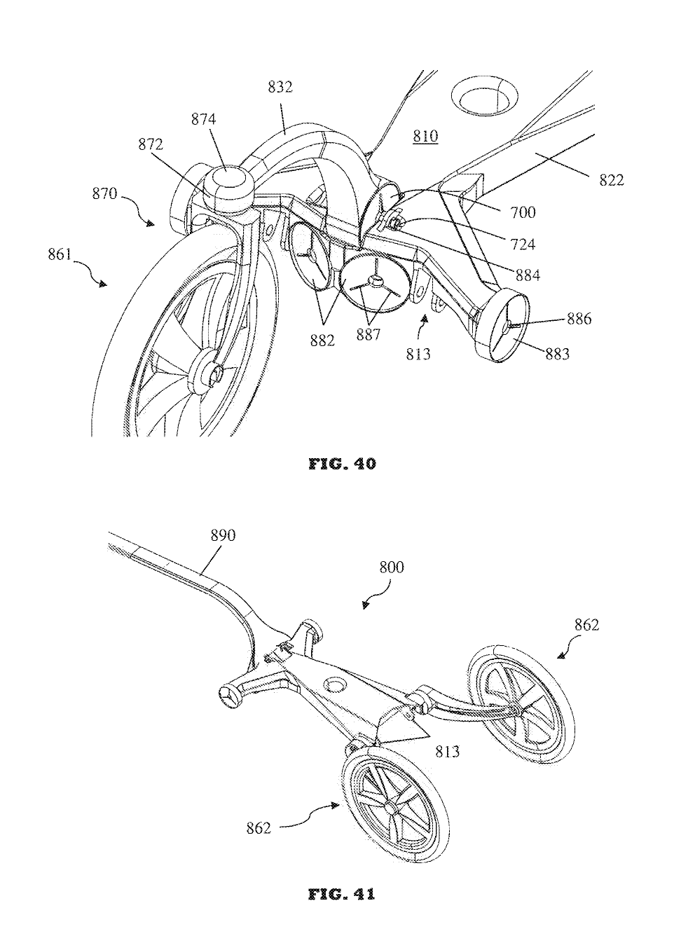

With specific reference to FIGS. 36 and 37, in one embodiment, base 810 may comprise seven spring unit seats 880. The forward portion of base 810 may include five spring unit seats 880, including inboard spring seats 882, outboard spring seats 883, and a center spring seat 881. In a four-wheeled stroller transport configuration, as shown in FIGS. 30 and 31, front suspension arms 832 may be coupled with inboard spring seats 882. The inboard spring seats 882 may be slightly angled with respect to a lateral axis Y to better accommodate front suspension arms 832. In a four-wheeled wagon transport configuration, as shown in FIGS. 33 and 34, front suspension arms 832 may be coupled with outboard spring seats 883. In a three-wheeled transport configuration, as shown in FIGS. 38, 39, and 40, a front suspension arm 832 may be coupled with center spring seat 881. As shown in FIG. 40, a front suspension arm 832 coupling a spring unit 700 may be inserted into the center spring seat 881. Recessed areas 834 may be located adjacent to center spring seat 881 to allow for a user to insert an axle pin 724 through the pin bore 716 of spring unit 700, and if disassembling the suspension arm 832 from the center spring seat 881, the recessed areas 834 may permit a user to remove the axle pin 724 with ease. In a two-wheeled transport configuration, as shown in FIG. 41, there are no front suspension arms 832 coupled to the front portion of base 810. In a one-wheel transport configuration, as shown in to FIGS. 42, 43, and 45, a front suspension arm 832 may be coupled to base 810 at the center spring seat 881 location just as it is in the three-wheeled transport configuration. In this configuration, the handle assembly 890 is coupled to the rear portion of the base 810. The one-wheel transport configuration may allow for a user to attach modular transporter 100 to a bike and tow the transporter at high speeds.

As shown in FIG. 35, front suspension arms 832 may each be coupled to a corresponding spring unit 700 at their arm proximal portions 830a. The arm proximal portion 830a of a front suspension arm 832 may include a spring unit coupler 840 that may be configured to be secured around the annular shape of a spring unit housing 702. Caster assemblies 870 may be coupled with the arm distal portions 830b of a given front suspension arm 832. Caster assemblies 870 may have a swivel assembly 872 that may allow for free rotation of the front wheels 861 for easy steering of modular transporter 100, and the caster assemblies 870 may be self-aligning. The swivel assemblies 872 may comprise a toe adjuster 874 to permit a front wheel 861 to be locked into a given toe position. For example, with reference to FIG. 39, a front wheel 861 may be locked into a toe position where the front wheel 861 is substantially parallel with a fore/aft axis X. When a front wheel 861 is locked into a toe position, the toe angle between the fore/aft axis X relative to the toe angle of the rear two wheels can be adjusted via an adjustment mechanism (not shown) to ensure safe and manageable straight line tracking, allowing a user to use or move modular transport 100 at higher speeds.

With reference again to FIGS. 32 and 35, the rear portion of base 810 is shown including two rear outboard spring seats 885. At the arm proximal portion 830a of each of the rear suspension arms 834, each rear suspension arm 834 is shown having a receiving cup 837 that cups and encloses a spring unit 700 when the rear suspension arms 832 are mounted to the base 810. Rear suspension arms 834 may have a plurality of connecting elements 836 located within a receiving cup 837 that may be operably coupled with corresponding cam mounts 714 of spring unit 700, thereby coupling a rear suspension arm 834 with a spring unit 700. Connecting elements 836 may also be housed outside of a receiving cup 837.

With reference to FIG. 45, at its arm distal portion 830b, a rear suspension arm 834 may have a hub connecting element 838 that may be linked with a hub assembly 850 of a rear tire 862. The hub connecting element 838 may be coupled with a quick release system in the hub assembly 850 such that the rear suspension arms 834 may be quickly connected to or disconnected from the wheel/tire assemblies 860.

With reference now to FIGS. 36, 38, and 46, base 810 may further comprise a pair of handle connection lugs 813 at both the forward and rear portions of base 810 such that a handle assembly 890 may be linked with base 810 at either its forward or rear portion. For example, handle assembly 890 may be coupled with base 810 at its front portion such that the modular transporter 100 may be pulled in a four-wheeled wagon transport configuration (FIG. 33), or alternatively, handle assembly 890 may be coupled with base 810 at its rear portion such that the modular transporter 100 may be pushed in a four-wheeled stroller transport configuration (FIG. 30). Handle assembly 890 may have a pair of handle mating connectors 895 that may mate with handle connection lugs 813 of base 810. Handle assembly 890 may be oriented in a standard position, as shown in FIG. 31, or in an inverted position, as shown in FIGS. 41 and 42.

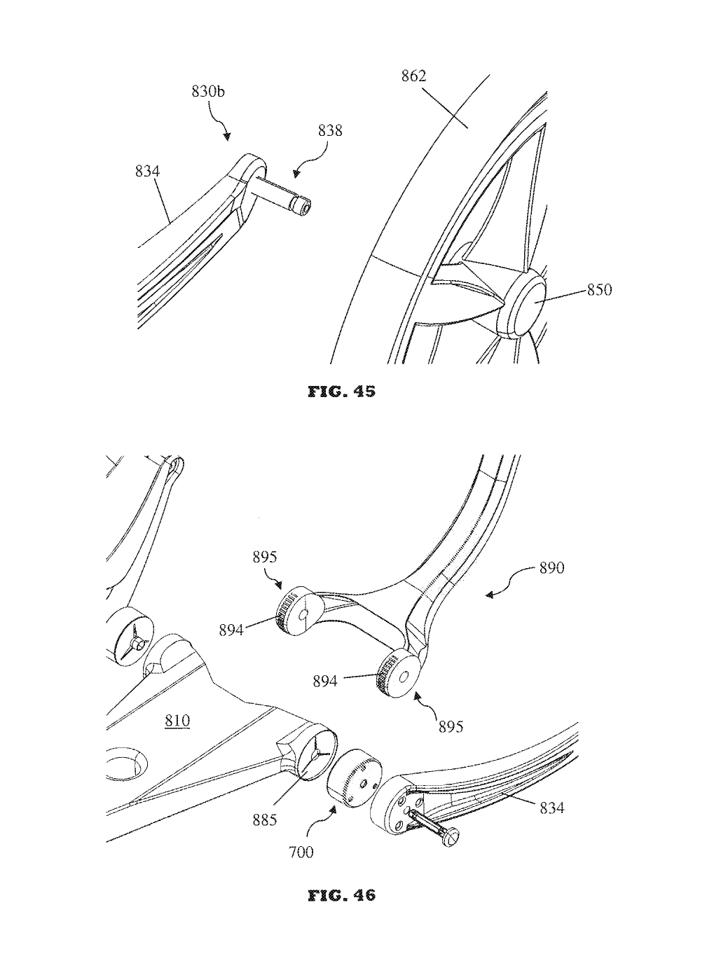

Referring specifically now to FIG. 46, handle mating connectors 895 may each have a ratchet element 894. The ratchet elements 894 may permit a user to select the desired orientation of the handle assembly 890. To adjust the handle assembly 890, a user may engage/release a ratchet adjuster 893 located adjacent to the grip handles 892, and then rotate the handle assembly 890 about a lateral axis Y by sequencing the ratchet element 894. A user may rotate the grip handles 892 to rotate the handle assembly 890 about a lateral axis Y. To lock handle assembly 890 in the desired position, the ratchet adjuster 893 may be released/engaged to reengage the ratchet element 894. The handle assembly 890 may also be telescopically adjustable such that modular transporter 100 may accommodate a wide variety of users and applications. The handle assembly 890 may be telescopically adjustable by means known in the art, such as the use of detent pins or guides, for example.

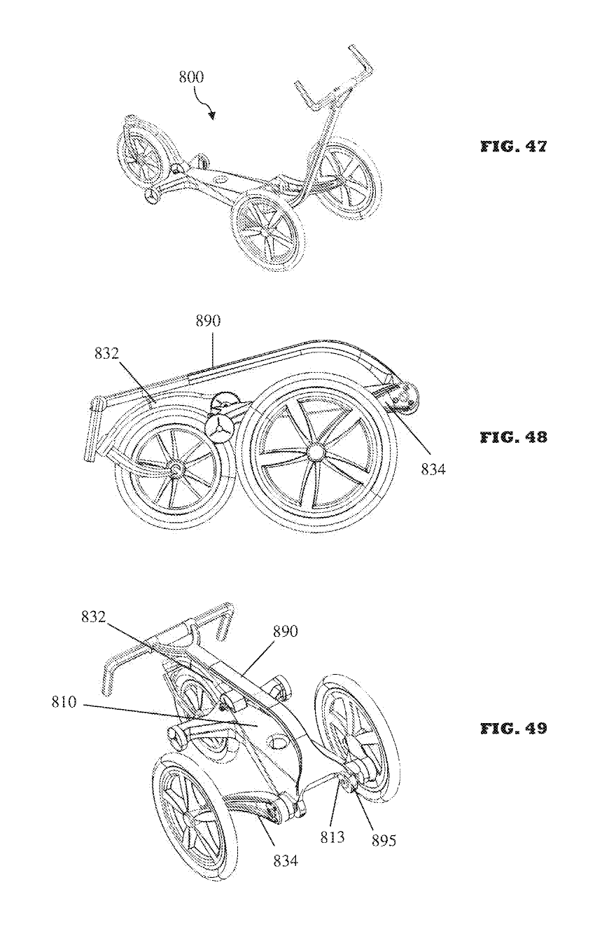

With reference now to FIGS. 47, 48, and 49, a three-wheeled universal chassis 800 is shown going from a transport configuration (FIG. 47) to a folded storage mode (FIGS. 48 and 49). When switching universal chassis 800 into a folded storage mode, handle assembly 890 may be folded across the length of base 810. If the handle assembly 890 is an inverted position (FIG. 41), the handle assembly 890 may be folded underneath base 890. The rear suspension arms 834 may be folded inwardly toward the center of base 890 in either a CW or CCW direction. Likewise, front suspension arm(s) 832 may be folded inwardly toward the center of base 890. In this manner, the silhouette and envelope of universal chassis 800 may be reduced, allowing it to be stored in more compact spaces.

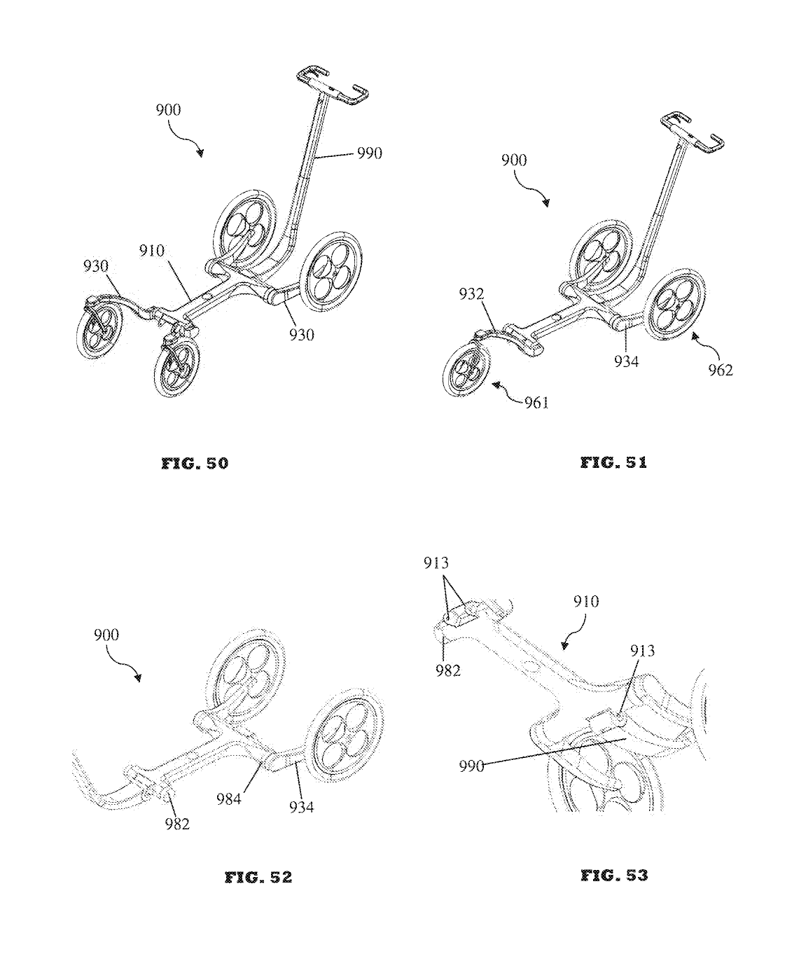

With reference to FIGS. 50-53, another exemplary embodiment of a universal chassis 900 is shown. In this embodiment, universal chassis 900 may comprise a base 910, a number of suspension arms 930, wheel/tire assemblies 960, and a handle assembly 990. Universal chassis 900 may have a user module 300 mounted thereto in the same fashion as described above for the other exemplary universal chassis 200, 800.

Base 910 is shown having a generally I-shaped frame with a plurality of spring unit seats 980. In this embodiment, base 910 may have two front spring unit seats 982 and two rear spring unit seats 984. Each of the spring seats 980 may be configured to receive a corresponding spring unit 700. Suspension arms 930 may be mountable to the base 910 in the manner described above for the rear suspension arms 834 of universal chassis 800. In this embodiment, front wheels 961 may be coupled with caster assemblies 970 and rear wheels 962 may be non-steered wheels.

In FIG. 50, universal chassis 900 is shown in a four-wheeled transport configuration. In FIG. 51, universal chassis 900 is shown in a three-wheeled transport configuration. In FIG. 52, universal chassis 900 is shown in a two-wheeled transport configuration. In FIG. 53, base 910 is shown having handle connection lugs 913 at its forward and rear portions. This may allow a user to attach a handle assembly 990 at the forward or rear portion of the base 910.

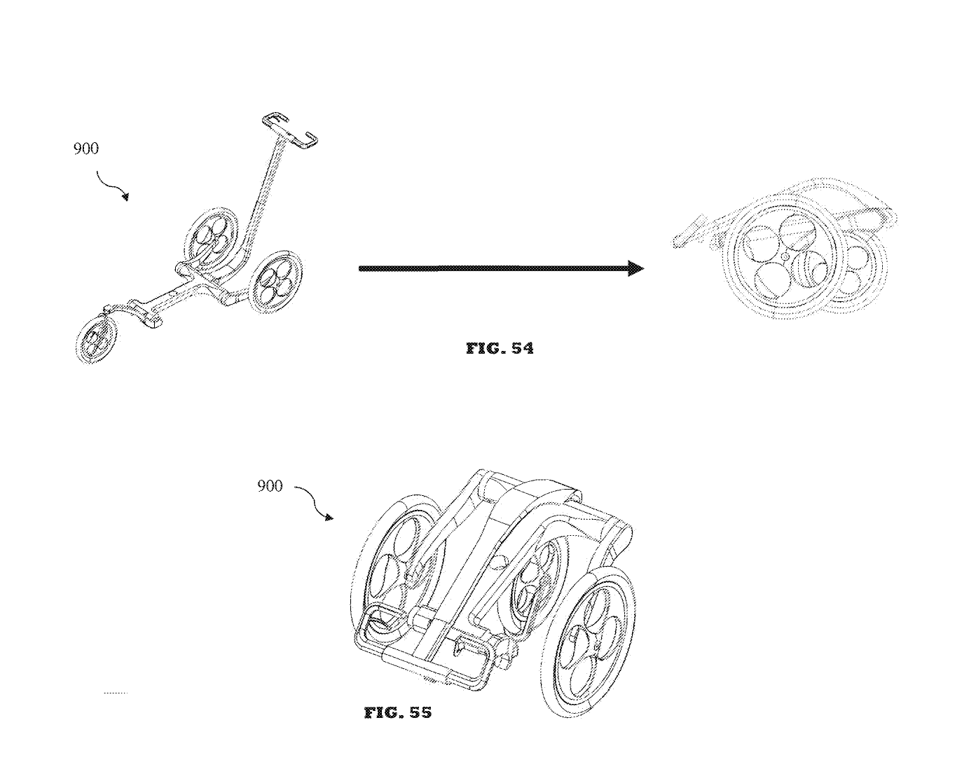

With reference to FIGS. 54 and 55, an exemplary universal chassis 900 is shown going from a three-wheeled transport configuration to a folded storage mode. To fold universal chassis 900 into a folded storage mode, the handle assembly 990 may be folded over the base 910, and the front suspension arm 932 and rear suspension arms 934 may be folded inward toward the center of base 910. In FIG. 55, a perspective view of an exemplary universal chassis 900 is shown in a folded storage mode.

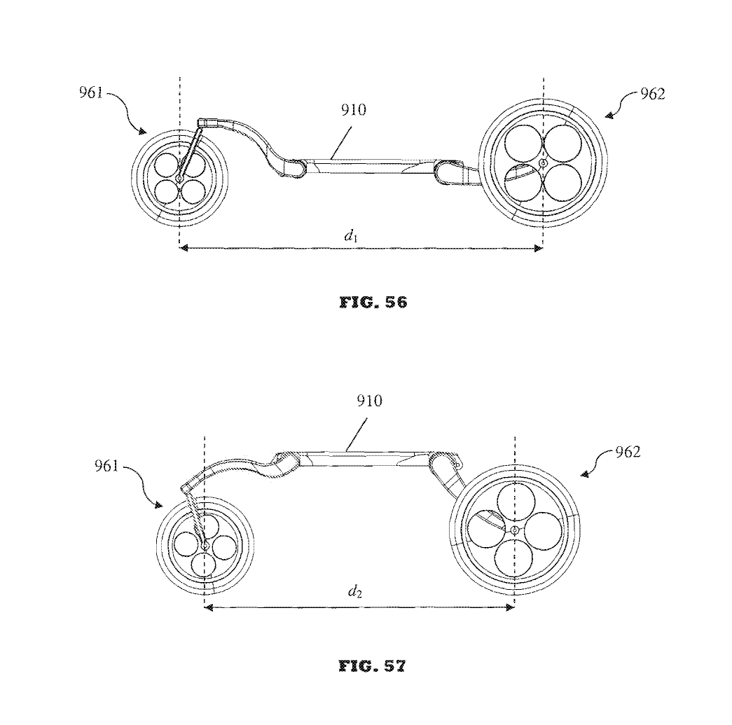

FIG. 56 shows an exemplary universal chassis in a jogging stroller transport configuration, and FIG. 57 shows an exemplary universal chassis in a walking stroller transport configuration. FIGS. 56 and 57 illustrate how the wheelbase may be adjusted depending on the desired use of universal chassis 900. In the jogging stroller transport configuration, as shown in FIG. 56, the wheelbase may be adjusted such that the distance d₁ between the front and rear axles is lengthen. Increasing the distance of the wheelbase effectively lowers the center of gravity of universal chassis 900, which in turn allows modular transporter 100 to achieve better stability at higher speeds. In the walking stroller transport configuration, as shown in FIG. 57, the wheelbase may be adjusted such that the distance d₂ between the front and rear axles is shortened. Reducing the wheelbase allows modular transporter 100 to be more maneuverable with a smaller turning radius. The wheelbase distance adjustment may be accomplished by rotating the suspension arms 230 and then locking the suspension arms 230 in the desired position. A release button (not shown) may be used to quickly adjust the wheelbase distance of universal chassis 900.

Spring Unit

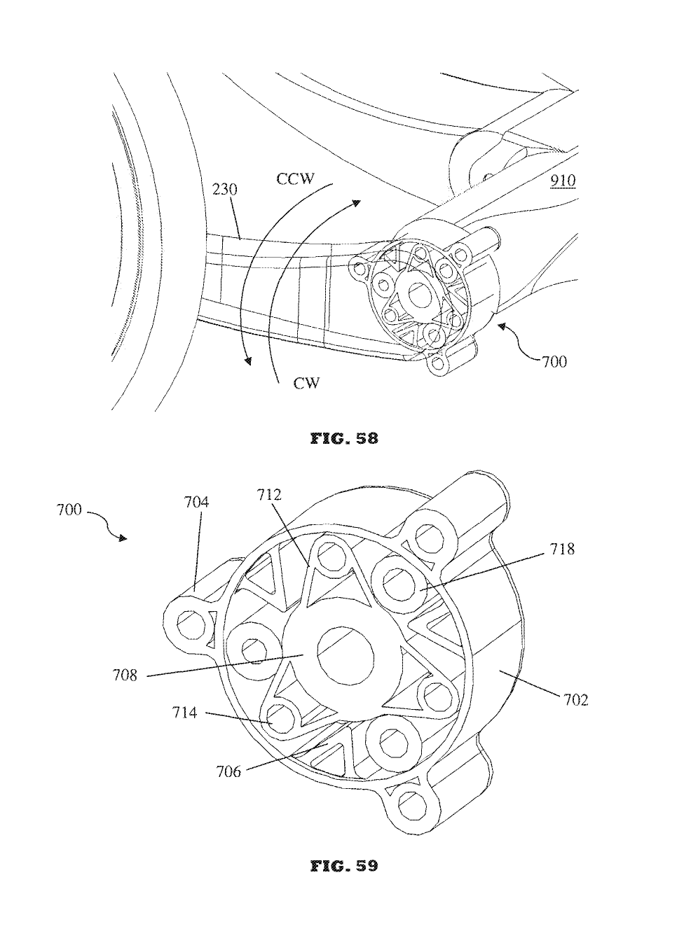

With general reference to FIGS. 58-61, spring unit 700 will now be described in more detail. In one embodiment, spring unit 700 may couple a suspension arm 230 with a structural frame, such as a universal chassis 200, 800, or 900, and may operably control the sprung weight of a modular transporter 100 by managing the vertical loads from road inputs and sprung masses, thereby controlling ride height position and improving ride quality. In FIG. 58, suspension arm 230 is shown coupled to a universal chassis 200 by a spring unit 700 (suspension arm 230 is shown transparent for illustrative purposes). When modular transporter 100 experiences a load, such as a bump in the road, suspension arm 230 may rotate CW or CCW depending on axle position and configuration. As the suspension arm 230 rotates to permit the tire 264 to maintain contact with the ground throughout the bump (i.e., maintain a TCP), spring unit 700 acts to counteract and absorb the relevant forces.

Referring still to FIGS. 58-61, spring unit 700 may comprise a spring unit housing 702, a plurality of stops 706, a cam hub 708 coupled with a plurality of cam elements 712 extending radially therefrom, a plurality of compression springs 718, and end plates 726, 728.

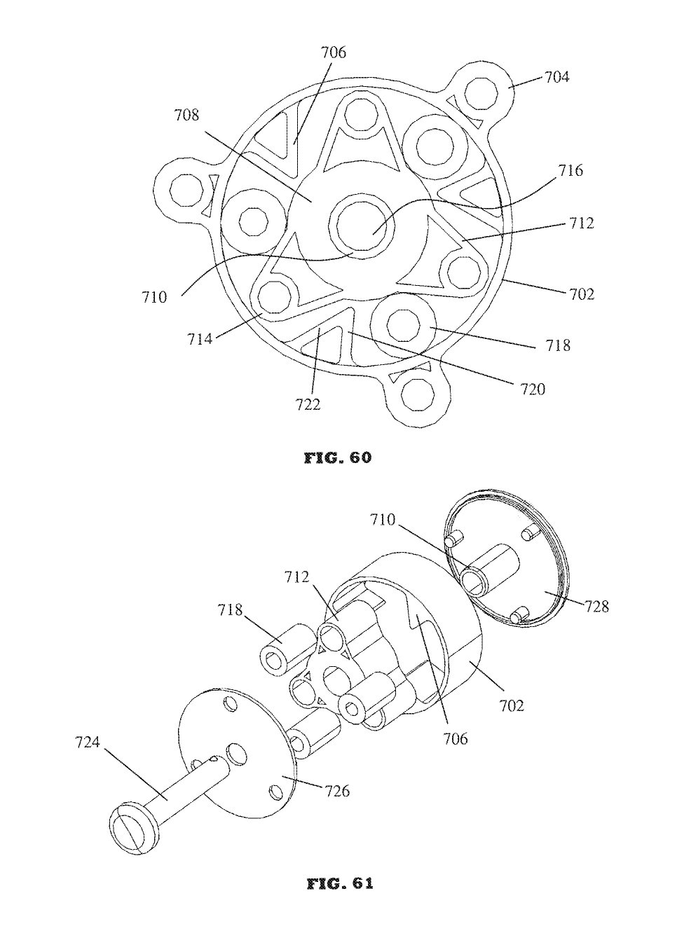

Spring unit housing 702 provides a casing to protect and encompass the internal components of spring unit 700. The spring unit housing 702 may have a generally annular shape, as shown in FIG. 60. A first end plate 726 and a second end plate 728 may enclose the internal components of spring unit 700 axially.

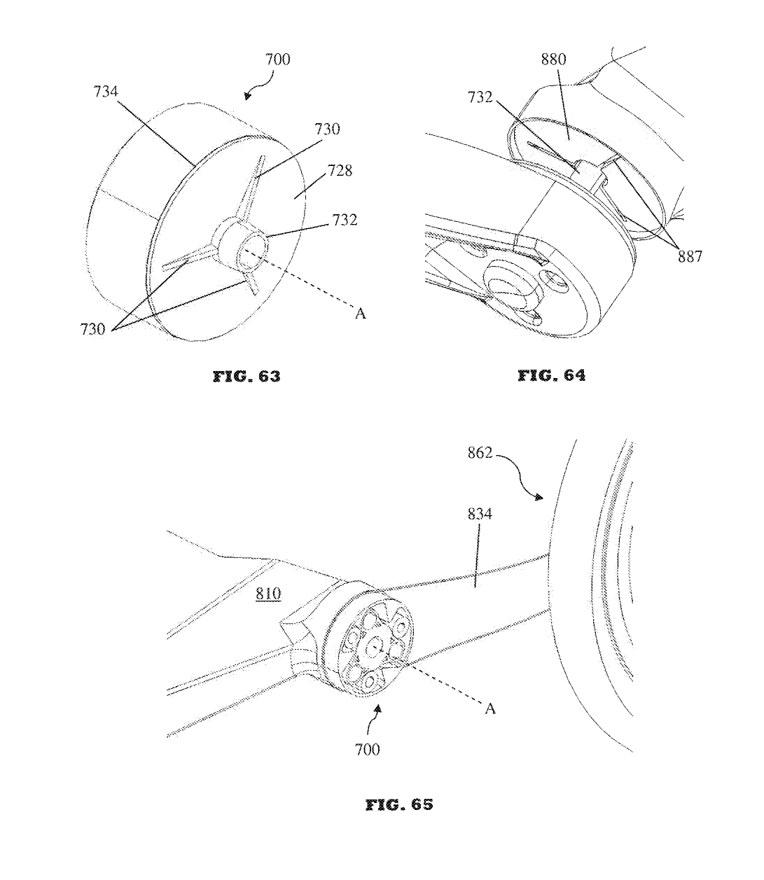

The spring unit housing 702 may optionally comprise housing mounts 704 that may enable the spring unit 700 to be mounted to a structural frame, such as a universal chassis 200, 800, or 900. In another embodiment, with reference specifically to FIGS. 63, 64, and 65, a spring unit 700 may also mount to a structural frame by an axle pin 724, which may be a quick-release axle pin. Furthermore, second end plate 728 may comprise a plurality of flanges 730 that may each be configured to mate with a corresponding flange guide 887 located within a spring unit seat 880. Flanges 730 may be tapered. In FIG. 63, three flanges 730 are shown in one possible configuration and are disposed approximately one hundred and twenty (120) degrees apart from one another and shown tapering radially outward from the axis of rotation A. The flange guides 887 may each have geometry complementary to the geometry of the flanges 730 such that spring unit 700 may be mounted flush against a spring unit seat 880. In this manner, the orientation and the geometry of flanges 730 and each of their corresponding flange guides 887 may assist a user in assembling a suspension arm 230 to a structure with the correct orientation.

End plate 728 may also comprise a locator 732 that may be configured to mate with a locator guide 886 of a spring unit seat 880. The locator 732 may be tapered, allowing a user to quickly locate and mount the spring unit 700 (and possibly an attached suspension arm 230) to a spring unit seat 880 of a structural frame. The locator guide 886 of the spring unit seat 880 may have geometry complementary to the geometry of the locator 732. End plate 728 may also have a circumferential guide 734, which may be a tapered, chamfered, beveled or rounded edge for example, outlining the circumference of end plate 728 to further assist a user in mounting spring unit 700 to a spring unit seat 880.

As noted above, spring unit 700 may comprise a plurality of compression elements, or stops 706. In one embodiment, stops 706 may be coupled with and annularly disposed about an internal face of the spring unit housing 702. Each stop 706 may extend radially inward toward a cam hub 708. Stops 706 may be a generally triangular shape as shown in FIG. 60, or alternatively, stops 706 may be other shapes as well, so long as the shape of each stop 706 permits a corresponding cam element 712 to engage (come into contact with) and compress it when the cam elements 712 are rotated about an axis of rotation A. Cam hub 708 may be coupled with a bearing 710, which may facilitate rotation of cam hub 708 about pin bore 716. Bearing 710 may be coupled to the cam hub 708, or it may be coupled directly to second end plate 728 as shown in FIG. 61. Pin bore 716 may be configured to accept an axle pin 724. Axle pin 724 may allow a user to quickly release or engage a suspension arm 230 from or to a structural frame. FIG. 64 shows an exemplary spring unit 700 being mounted to an exemplary spring unit seat 880, and FIG. 65 shows spring unit 700 coupling a rear suspension arm 834 with base 810 (the suspension arm 230 is shown transparent for illustrative purposes).

A plurality of cam elements 712 may extend from cam hub 708. Each cam element 712 may be configured to extend radially outward from cam hub 708. Cam elements 712, along with the cam hub 708, may be configured to rotate either CW or CCW when a load is applied to spring unit 700. It should be noted that stops 706 may alternatively be coupled with a structural element other than the spring unit housing 702, such as an axially adjacent end plate, so long as the stops 706 may be engaged and compressed by a corresponding cam element 712 when the cam elements 712 and cam hub 708 rotate about an axis of rotation A. Each cam element 712 may have a cam mount 714. Cam mounts 714 may enable a suspension arm 230 or other structural components to be mounted to cam elements 712.

Optionally, a plurality of compression springs 718 may be disposed generally annularly about the internal face of the spring unit housing 702 and may be placed between cam elements 712 and stops 706. More specifically, each compression spring 718 may be constrained between cam elements 712, cam hub 708, and the spring unit housing 702; the compression springs 718 are not fixed to these elements, but rather the compression springs 718 are only constrained by them. Compression springs 718 may have a generally cylindrical shape and may be comprised of rubber, composite, gels, foam, and/or plastic materials, for example.

When a vertical load is applied to either the wheel TCP through a road input or through sprung mass loading on the modular transporter 100, a suspension arm 230 may be forced to rotate. As the suspension arm 230 rotates, a load is in turn applied to spring unit 700. Specifically, when a suspension arm 230 rotates, this may rotate cam elements 712, as the suspension arm 230 may be coupled with the cam elements 712 via cam mounts 714.

In one embodiment, as the cam elements 712 rotate, they may each engage a corresponding compression spring 718. When a cam element 712 engages a compression spring 718, the cam element 712 may move or roll the compression spring 718 toward a compression element, or stop 706. The cam element 712 may compress the compression spring 718 against a stop 706. If a load is applied that would cause the cam elements 712 to rotate in the opposite direction, a cam element 712 may directly engage a corresponding stop 706. It should be noted that stops 706 may be made of the same or similar material as the compression springs 718 and that stops 706 should be made of a material that is strong and rigid enough to allow a compression spring 718 to compress against the stop 706 (or strong and rigid enough to allow a cam element 712 to directly compress the stop 706) without breaking, and elastic enough to allow for a cam element 712 to engage and compress the stop 706. Thus, each stop 706 may have compression spring contact portion 720 and a cam element contact portion 722. The compression spring contact portion 720 and cam element contact portion 722 may be made of different materials, as in the compression spring contact portion 720 may be made of a more rigid material and the cam element contact portion 722 may be made of a more elastic material. Alternatively, the compression spring and cam element contact portions 720, 722 may be made of the same material.

In one embodiment, spring unit 700 may be a system that progressively stiffens as the cam elements 712 are rotated about an axis of rotation A. Meaning, the spring unit 700 may gradually stiffen in stages.

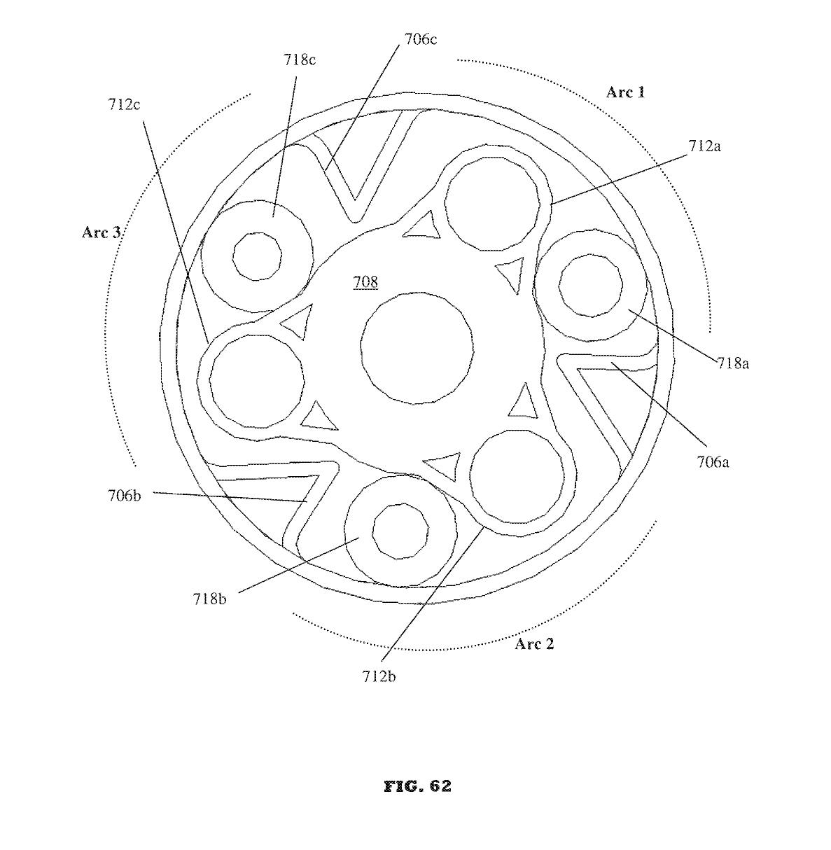

With reference now to FIG. 62, a four-stage spring rate unit is shown. In this embodiment, spring unit 700 may comprise a first compression spring 718a, a second compression spring 718b, and a third compression spring 718c. Each of the compression springs 718 may have differing spring rates (stiffness), or they may all have the same spring rates. Spring unit 700 may also comprise a first stop 706a, a second stop 706b, and a third stop 706c. Each stop 706 may have differing spring rates as well, or they too may all have the same spring rates. Moreover, spring unit 700 may have a first cam element 712a, a second cam element 712b, and a third cam element 712c.

In this embodiment, stops 706 may be disposed annularly about the spring unit housing 702 at differing arc distances from one another. For example, Arc 1 may be the arc distance from third stop 706c to first stop 706a; Arc 2 may be the arc distance from first stop 706a to second stop 706b; and Arc 3 may be the arc distance from second stop 706b to third stop 706c. The arc distance of Arc 1 could be greater than the arc distance of Arc 2, and the distance of arc 2 could be greater than the distance of arc 3. In other words, Arc 1>Arc 2>Arc 3. This permits the cam elements 712 to engage and compress their corresponding compression springs 718 against their respective stops 706 sequentially if an applied load forces the cam elements to move CW, or if an applied load forces the cam elements 712 in a CCW direction, it will permit the cam elements 712 to engage and compress the stops 706 sequentially.

In FIG. 62, spring unit 700 is shown in first stage. In the first stage, in this example, no load is applied to the system or the load is so small that the cam elements 712 have not yet engaged any of the stops 706 or compression springs 718. In the first stage, spring unit 700 has a first stiffness. The number of the stiffness, i.e., the “first” in first stiffness simply defines what stage the spring unit 700 has progressed to. The stiffness of a system may be variably within a particular stage depending on the magnitude of the applied load.

Spring unit 700 may reach a second stage if a load is applied that will cause the cam elements 712 to rotate in such a way that a first cam element 712a will engage and move first compression spring 718a toward first stop 706a (if moving in a CW direction). If the magnitude of the applied load is of a sufficient magnitude, the first cam element 712a will compress the first compression spring 718a against the first stop 706a. Accordingly, spring unit 700 will have a second stiffness in the second stage.

Spring unit 700 may reach a third stage if the magnitude of the applied load is great enough to overcome the spring rate of the first compression spring 718a and a second cam element 712b begins to engage and compress a second compression spring 718b (if the second cam element 712b has not already engaged the second compression spring 718b) and will move it or continue to move the second compression spring 718b toward second stop 706b. If the magnitude of the applied load is of a sufficient magnitude, the second cam element 712b will compress the second compression spring 718b against the second stop 706b. As both the first compression spring 718a and second compression spring 718b are engaged and compressed, the two compression springs act to create a non-linear spring system. In other words, when the first and second compression springs 718a and 718b are compressed, the stiffness of the compression springs 718 increases exponentially. Accordingly, spring unit 700 will have a third stiffness in the third stage.

Spring unit 700 may reach a fourth stage if the magnitude of the applied load is great enough to overcome the spring rate of the non-linear spring rate provided by the first and second compression springs 718a, 718b and corresponding stops 706. If such a load is applied, a third cam element 712c will engage a third compression spring 718c (if the third cam element 712c has not already engaged the third compression spring 718c) and will move or continue moving the third compression spring 718c toward third stop 706c. If the magnitude of the applied load is of a sufficient magnitude, the third cam element 712c will compress the third compression spring 718c against the third stop 706c. If all three of the compression springs 718 are compressed, the spring unit 700 will have an even greater non-linear spring rate than in the third stage. In the fourth stage, spring unit 700 will have a fourth stiffness.

Referring still the embodiment shown in FIG. 62, if a load is applied to spring unit 700 that will cause the cam elements 712 to rotate in a CCW direction, the cam elements 712 will sequentially engage stops 706. As multiple stops 706 may be engaged, the spring unit 700 may have a non-linear spring rate in a CCW direction as well. Moreover, spring unit 700 will progressively stiffen in stages as the cam elements 712 engage the stops 706.

In another embodiment, an embodiment may have all the same features as the embodiment shown in FIG. 62 and described in the accompanying text except that a spring unit 700 may have compression springs 718 on both sides of the cam elements 712, which would prevent the cam elements 712 from directly engaging the stops 706. Rather the cam elements 712 would engage compression springs 718 no matter the direction of motion. In this embodiment, a non-linear spring rate may be achieved in either a CW or CCW direction. Furthermore, spring unit 700 would progressively stiffen in stages as the cam elements would still sequentially compress the compression springs 718 against the stops 706.

In another embodiment, an embodiment may have all the same features as the embodiment shown in FIG. 62 and described in the accompanying text except that a spring unit 700 may not comprise compression springs 718. In this embodiment, a non-linear spring rate may still be achieved in either a CW or CCW direction. Additionally, spring unit 700 would progressively stiffen in stages as the cam elements would still sequentially compress the stops 706 as Arc 1>Arc 2>Arc 3.

In another embodiment, the arc distances between the stops 706 may all be equal (i.e., Arc 1=Arc 2=Arc 3). In this embodiment, the geometry and material stiffness of stops 706 may be designed in such a way that their stiffness and geometry determine the spring rate when engaged by cam elements 712. In this embodiment, a non-linear spring rate may be achieved in either a CW or CCW direction, and spring unit 700 will still progressively stiffen in stages.

In this embodiment, spring unit 700 could progressively stiffen in four-stages. In this embodiment, spring unit 700 may have three stops 706 disposed along the internal face of spring unit housing 702 at equal arc distances from one another with no compression springs 718. The stops 706 may each have differing geometry such that when cam elements 712 engage their corresponding stop 706, the cam elements would actually begin to compress the stops 706 at different times. This could be accomplished, for example, by angling the stops 706 at different angles.

The first stage would be where no load is applied to the spring unit 700 or when a load is so small that the cam elements 712 have not yet engaged any of the stops 706. In the first stage, spring unit 700 would have some but very minimal stiffness, which may be variable and denoted as a first stiffness.

To reach the second stage, at least one cam element 712 would begin to compress at least one stop 706. The spring unit 700 would start to stiffen in a linear fashion if the compression element comprised a linear spring rate, or spring unit 700 could alternatively stiffen in a non-linear fashion if the stop 706 is a non-linear compression element. From stage one to stage two, the spring unit 700 may progress from a minimal first stiffness to a second stiffness.

If an applied load is of sufficient magnitude, spring unit 700 will reach a third stage. To reach the third stage, a second cam element 712 may begin to compress a corresponding stop 706. In the third stage, as two stops 706 are now being compressed, an overall non-linear spring rate is achieved. From stage two to stage three, the spring unit 700 has progressed from a second stiffness to a third stiffness, or a third stage of stiffness.

If an applied load is of sufficient magnitude, spring unit 700 will reach a fourth stage. To reach a fourth stage, a third cam element 712 may begin to compress a corresponding stop 706. In the fourth stage, as three compression elements 706 are now being compressed, the overall non-linear spring rate becomes even more non-linear than the third stage. From stage three to stage four, the spring unit 700 has progressed from a third stiffness to a fourth stiffness.

Various components of spring unit 700 may be tuned such that a desired progressive spring rate is achieved. The geometry of the cam elements 712, stops 706, or compression springs 718 may be tuned such that spring unit 700 progressively stiffens in stages as cam elements 712 are rotated about an axis of rotation A. The angular gap (or effective Arc distance) between cam elements 712 or stops 706 may also be tuned such that spring unit 700 progressively stiffens in stages as cam elements 712 are rotated about an axis of rotation A. Likewise, the material stiffness properties of the cam elements 712, stops 706, or compression springs 718 may also be tuned such that as cam elements 712 are rotated about an axis of rotation A, spring unit 700 progressively stiffens in stages.

Modular Storage System

Referring now to FIG. 66, a modular storage system 400 is illustrated. A modular storage system 400 may house a universal chassis 200, as shown in FIG. 66, a variety of user modules 300, or virtually any other item that may fit within the dimensional confines of modular storage system 400. Universal chassis 200, 602, 800, 900, user modules 300, or other items may be secured within the modular storage system 400 by brackets 426 (not shown), which engage and hold the particular item in place during transport. Modular storage system 400 may comprise of all-weather materials that allow a system to be housed indoors and/or outdoors, and may be liquid, moisture, and insect proof.

Modular storage system 400 includes a top portion 402, a bottom portion 404, a front 405 portion, a back portion 406, and side portions 408 that define a length L, a width W, and a depth D of the system. As shown in FIG. 67, the depth D of modular storage system 400 is greater toward its bottom portion 404 than it is toward its top portion 402. Accordingly, each side portion 408 has a base portion 410 having a consistent depth D and a narrowing portion 412 having a narrowing depth D. The narrowing of the depth D of the modular storage system 400 effectively lowers the systems center of mass, making the system more stable generally but especially when modular storage system 400 is being moved about on its multidirectional casters 414 in a vertical position (or upright position) as shown in FIG. 66. Modular storage system 400 may also include casters 414 at its top portion 402 to allow for modular storage system 400 to be moved about the ground in a horizontal position.

Modular storage system 400 may also comprise an access door 416 that may be opened and closed, and may be lockable to secure the contents stowed in modular storage system 400. The access door 416 may be retractable and may roll up and down. Access door 416 may be locked by any number of methods, including a key, a lock bar, an electronic locking system, or may include a magnetized portion 418 at its end that mates with a magnetic joint 420 located at the bottom portion 404 of modular storage system 400. The magnetization of magnetic joint 420 and the magnetized portion 418 on access door 416 may be controlled by a controller (e.g. a hand held device) having the ability to communicate with a receiver of microprocessor 422 located on the modular storage system 400 such that the access door 416 may be locked and unlocked. Electronic locking systems may also be controlled by microprocessor 422.

Microprocessor 422 may be used for virtually any task to control the modular storage system 400. For example, courtesy lighting for garage visibility may be controlled by microprocessor 422 via a controller, or if modular storage system 400 is mounted to a trailer hitch of a vehicle, lights on the modular storage unit 400 may be synched to the vehicle's rear signals, which may be controlled by microprocessor 422 via a link to an electronic control unit (ECU) of the vehicle. Additionally, modular storage systems 400 are highly customizable, and may include a cool box, fridge, cookers, et cetera that may be controlled by microprocessor 422 via a hand held device, or if the modular storage system 400 is in communication with a vehicle, by an instrument panel, voice command or other known vehicle controllers having communication functionality.

Side portions 408 of modular storage system 400, as well as other portions, may include a top cam locking system retainer 428 and a bottom cam locking system retainer 429 as shown in FIG. 66. The top and bottom locking system retainers 428, 429 allow for cam locking systems 550 located on a linking system 500 to be inserted into the retainer portions for secure engagement of the linking mechanism 500 to the modular storage system 400. The cam locking systems 550 will be described in greater detail herein. Side portions 408 may also include linking connects 424 that may be notches, grooves, indentations, recessed portions, hooks, or any other type of connecting mechanism that allow for cables, bungee cords, tie-downs, and the like to link to modular storage system 400.

Linking Mechanism

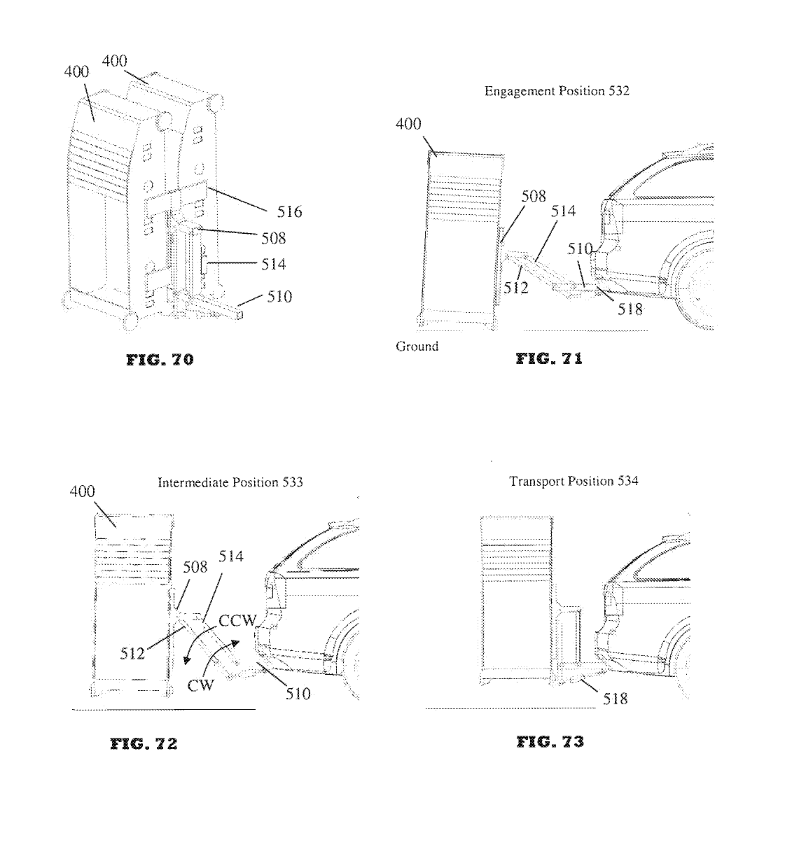

Referring generally to FIGS. 67-76, a linking mechanism 500 may link one or more modular storage systems 400 to a vehicle hitch 504 of a vehicle 502 to facilitate transportation of universal chassis 200, user modules 300, and other items stowed within modular storage systems 400. The modular storage systems 400 are first positioned and engaged with linking mechanism 500 at an engagement position 532. Once the modular storage systems 400 are engaged, the linking mechanism 500 operates to lift or raise the storage systems from the ground (engagement position) to a transport position 534, which may be a predetermined ride height suited for a particular vehicle or application. The kinematics of the linking mechanism 500 ensure that as the modular storage systems 400 are moved from the engagement position 532 to the transport position 534, or vice versa, that the contents within modular storage systems 400 remain level. Once raised to the transport position 534, the modular storage systems 400 may be rotated ninety degrees such that the storage systems are laid substantially horizontal (or roughly parallel to the ground). Rotating the modular storage systems 400 ninety degrees ensures vehicle rear view visibility. It should be noted that modular storage systems 400 may be oriented vertically or horizontally in transport position 534.

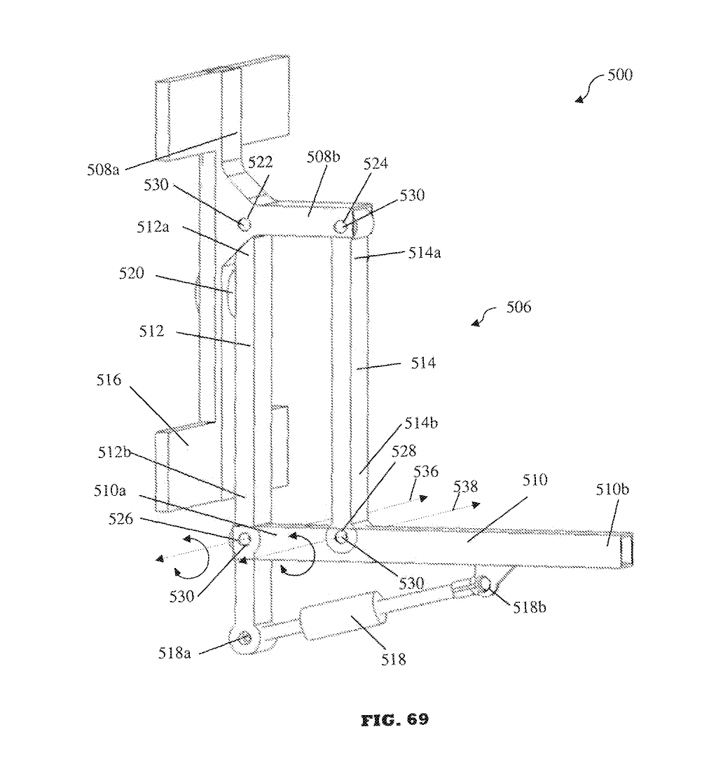

The linking mechanism 500 may comprise a plurality of links 506. In the embodiment shown in FIG. 69, there are a total of four main links 506, including: storage connecting link 508, vehicle link 510, vertical link 512, and support link 514. Storage connecting link 508 may directly engage a modular storage system 400 as shown in FIG. 67, or it may attach to an H plate 516 or like structure as shown in FIG. 69. As noted previously, the top and bottom cam locking system retainers 428, 429 of modular storage system 400 may allow for cam locking systems 550 to link linking mechanism 500 to modular storage system 400 for secure engagement.

Linking mechanism 500 can be positioned such that the cam locking systems 550 are aligned with the top and bottom cam locking system retainers 428, 429. The linking mechanism 500 can then engage modular storage system 400 by insertion of the cam locking systems 550 into the top and bottom cam locking system retainers 428, 429. Once the cam locking systems 550 (which includes a top and a bottom system), the system can be moved between an unlocked position 555 and a locked position 556, as will be described in more detail below.

With reference now to FIGS. 68A-68E, in one embodiment, cam locking systems 550 may include a locking system housing 551 that may be fit into or onto an H plate 516 or storage connecting link 508 of linking mechanism 500. An eccentric pin 553 is mounted in locking system housing 551 and connected at its head portion 553a with an eccentric handle 554. At its eccentric pin distal portion 553b, eccentric pin 553 is linked with an eccentric locking plate 552. To move the cam locking systems 550 between an unlocked position 555 and a locked position 556, a user may move the eccentric handle 554 in a CW or CCW direction, which in turn rotates the eccentric pin 553 causing the eccentric locking plate 552 to move into or out of locking engagement 557 with recessed portion 430 of the top and bottom cam locking system retainers 428, 429.

FIGS. 68B and 68C show the cam locking system 550 in an unlocked position 555. The eccentric locking plate 552 is shown aligned with the locking system housing 551 (i.e., the eccentric locking plate 552 is not protruding beyond the circumference of the locking system housing 551). To move to a locked position 556, the eccentric handle 554 is moved in a CCW direction (in the shown in FIG. 68D). This causes the eccentric pin 553 to rotate which in turn causes the eccentric locking plate 552 to rotate about its off center axis of rotation in an upward and leftward movement as shown in FIG. 68D. FIG. 68E shows the locking plate 552 in locking engagement 557 with the recessed portion 430 of a cam locking system retainer 428, 429.

To move from the locked position 556 to an unlocked position 555, eccentric handle 524 is moved a CW direction (in the embodiment shown in FIG. 68D). This causes the eccentric pin 553 to rotate which in turn causes the eccentric locking plate 552 to rotate about its off center axis of rotation in an downward and rightward movement such that the eccentric locking plate 552 realigns with the locking system housing 551. In FIG. 68C, the eccentric locking plate 552 is shown out of locking engagement 557 with the recessed portion 430. Once the eccentric locking plate 552 is realigned with the locking system housing 551, the cam locking systems 550 can be removed from the top and bottom cam locking system retainers 428, 429, and the linking mechanism 500 can be disengaged from the modular storage systems 400.

Storage connecting link 508 has a vertical storage link 508a and a horizontal storage link 508b. The vertical storage link 508a is the portion of the storage connecting link 508 that links directly to a modular storage system 400 or to an H plate 516. The horizontal storage link 508b is connected substantially normal to vertical storage link 508a, and is generally disposed parallel to the ground. As will be described in greater detail herein, horizontal storage link 508a links with vertical link 512 and support link 514 at their top portions, which are both in turn linked with vehicle link 510 at their bottom portions. Vehicle link 510 is generally disposed parallel to the ground, and may be coupled to a vehicle hitch 504 at its vehicle link distal end 510b. As the linking mechanism 500 moves a modular storage system 400 from an engagement position 532 to a transport position 534, the vehicle link 510 is held stationary throughout the movement.

The horizontal storage link 508b links with vertical link 512 and support link 514 at their top portions and vehicle link 510 links with vertical link 512 and support link 514 at their bottom portions. Vertical link 512 has a vertical link top portion 512a and a vertical link bottom portion 512b. Vertical link top portion 512a is pivotably coupled to horizontal storage link 508b at a first top linking point 522. Vertical link bottom portion 512b is pivotably coupled to vehicle link 510 at a first bottom linking point 526. Vertical link 512 is further linked to one end of actuator 518 at a first actuator linking point 518a.

Support link 514 has a support link top portion 514a and a support link bottom portion 514b. Support link top portion 514a is pivotably coupled to horizontal storage link 508b at a second top linking point 524. Support link bottom portion 514b is pivotably coupled to vehicle link 510 at a second bottom linking point 528. At each linking point, bearings 530 (e.g. pins) secured by mechanical fasteners such as washers, nuts, and cotter pins allow for pivotal movement of the vertical link 512 and support link 514.

The kinematics of the linking mechanism 500 moving a modular storage system 400 from an engagement/unloading position 532 to a transport position 534 will now be described in detail. Starting in engagement/unloading position 532, as shown generally in FIG. 71, the modular storage system 400 is in the beginning stages of being lifted off the ground. The vehicle link 510 is shown attached to a vehicle hitch 504 of vehicle 502. Actuator 518, which attaches at one end to vehicle link 510 at a second actuator linking point 518b and its other end to vertical link 512 at first actuator linking point 518a, is in the fully compressed position. To raise or lift the modular storage system 400, vertical link 512 and support link 514 are rotated about first bottom axis 536 and second bottom axis 538, respectively. First bottom axis 536 is coaxial with the first bottom linking point 526, and second bottom axis 538 is coaxial with second bottom linking point 528. In the left side elevation view shown in FIG. 72, the vertical link 512 and support link 514 are rotated in a CW direction. As the bottom portions of the vertical link 512 and support link 514 rotate about their respective axes, their top portions are allowed to pivot at their respective top linking points 522, 524. As the top portions of the vertical link 512 and support link 514 are pivoting, the horizontal storage link 508b is translated upward and toward vehicle 502. In effect, the modular storage system 400 is lifted or raised into the transport position 534. In the transport position 534, as shown in FIG. 73, horizontal storage link 508b is substantially parallel to vehicle link 510, and vertical link 512 is substantially parallel to support link 514. The horizontal storage link 508b and vehicle link 510 are substantially normal to vertical link 512 and support link 514. Further, in transport position 534, actuator 518 is fully extended.

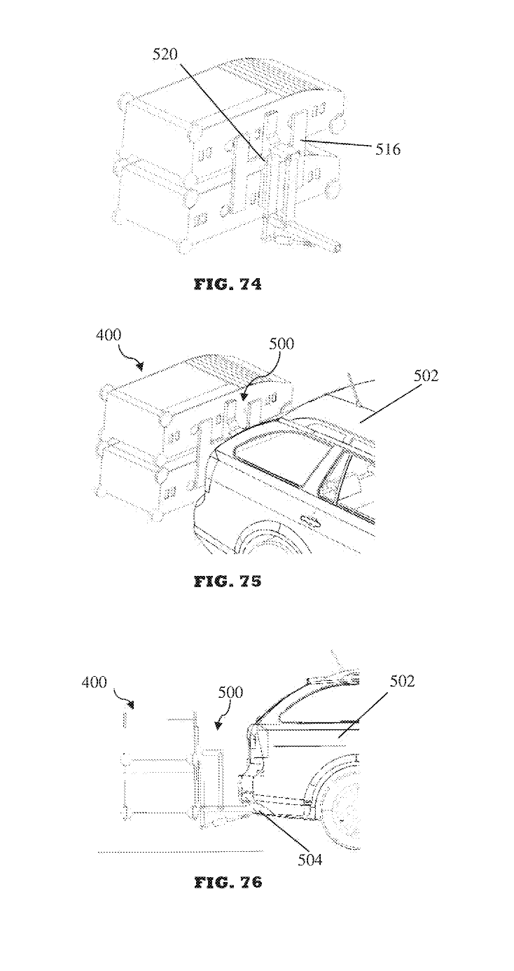

Referring specifically now to FIGS. 74-76, once modular storage systems 400 reach transport position 534, which for example may a predetermined ride height that is optimal to a particular vehicle, the modular storage systems 400 may be rotated horizontally to allow for better rear view visibility for a driver of vehicle 502. Of course, if the contents stowed within modular storage systems 400 are more appropriately held vertically, because the contents are fragile for example, then modular storage systems 400 may remain in the vertical position. If desired to rotate modular storage systems 400 to a horizontal position, a kinematic rotational joint 520 allows the modular storage systems 400 to move from the vertical position ninety degrees in a CW or CCW direction to a horizontal position. Thus, as shown in a left side elevation view in FIG. 76, a driver's rear view visibility is minimally impaired. Kinematic rotational joint 520 may include a locking mechanism (not shown) that secures the modular storage systems 400 in a horizontal position. When it is desired to unload modular storage systems 400 from the linking mechanism 500, the modular storage systems 400 may be rotated back to a vertical position via the kinematic rotational joint 520. The kinematic rotational joint 520 may linked with electric circuitry to a power source, such as the battery of vehicle 502. Alternatively, kinematic rotational joint 520 may be controlled via mechanical means, including the use of a crank handle (not shown), for example. In one embodiment, kinematic rotational joint 520 may be controlled by either electric or mechanical means.

To move a modular storage system 400 from a transport position 534 through an intermediate position 533 and to an engagement/unloading position 532, the linking mechanism 400 is generally allowed to rotate in a counter-clockwise (CCW) direction (from the left side elevation view in FIG. 72). To lower the modular storage system 400, vertical link 512 and support link 514 are rotated about first bottom axis 536 and second bottom axis 538, respectively. In the left side elevation view shown in FIG. 72, the vertical link 512 and support link 514 are rotated in a CCW direction. As the bottom portions of the vertical link 512 and support link 514 rotate about their respective axes, their top portions are allowed to pivot at their respective top linking points 522, 524. As the top portions of the vertical link 512 and support link 514 are pivoting, the horizontal storage link 508b is translated downward and away from vehicle 502. In effect, the modular storage system 400 is lowered into the engagement/unloading position 532. Actuator 518 slowly compresses to permit controlled movement of the linking mechanism 500 from the transport position 534 to the engagement/unloading position 532. When the linking mechanism 500 has reached the engagement/unloading position 532, actuator 518 is fully compressed. Vertical link 512 is linked to one end of actuator 518 at actuator linking point 518a. As vertical link 512 is rotated, actuator 518 permits controlled movement of the vertical link 512 and more broadly the linking mechanism 500 as a whole. Actuator 518 may control the movement of the linking mechanism 500 from the engagement/unloading position 532 to the transport position 534, and vice versa. Actuator 518 may be a mechanical or an electro-mechanical actuator. Actuator 518 may receive power from a power source, such as the battery of a vehicle 502 for an electro-mechanical actuator, or a crank handle for a purely mechanical actuator, for example.

The words used herein are understood to be words of description and not words of limitation. While various embodiments have been described, it is apparent that many variations and modifications are possible without departing from the scope and sprit of the invention as set forth in the appended claims.

What is claimed as new and desired to be protected by Letters Patent of the United States is:

1. A modular transporter, comprising:
a universal chassis configurable in a plurality of transport configurations, said universal chassis comprising a base having a top, a bottom, and sidewalls extending therebetween, said sidewalls having complex geometric surfaces, and said base comprising a receiving connector;
at least one suspension arm removeably connectable with said base;
at least one wheel configured to be coupled with said suspension arm; and
a user module comprising an undercarriage having engagement surfaces substantially complementary to said complex geometric surfaces of said universal chassis and a mating connector, said mating connector configured to mate with said receiving connector, and said engagement surfaces configured to engage said complex geometric surfaces.

2. The modular transporter of claim 1, wherein said plurality of transport configurations include a four-wheeled configuration, a three-wheeled configuration, a two-wheeled configuration, and a one-wheeled configuration.

3. The modular transporter of claim 1, wherein said user module further comprises a bump stop configured to engage said suspension arm, wherein said bump stop is adjustable along a fore/aft axis of said undercarriage for adjusting the engagement position of said bump stop with said suspension arm.

4. The modular transporter of claim 1, wherein said complex geometric surfaces are tapered surfaces.

5. The modular transporter of claim 1, wherein a handle assembly is coupled with said base for steering said modular transporter, said handle assembly being configured to be telescopically and rotationally adjustable.

6. The modular transporter of claim 1, wherein a knuckle/hub assembly couples said wheel with said suspension arm, said knuckle/hub assembly configured to allow said wheel to be folded about a fold axis.

7. The modular transporter of claim 1, wherein said mating connector comprises a shaft having a proximal diameter and a distal diameter, said proximal diameter greater than said distal diameter, and wherein said receiving connector comprises a receiving bore having a proximal bore diameter and a distal bore diameter, said distal bore diameter greater than said proximal bore diameter.

8. The modular transporter of claim 1, wherein said receiving connector comprises a shaft having a proximal diameter and a distal diameter, said proximal diameter being greater than said distal diameter, and wherein said mating connector comprises a receiving bore having a proximal bore diameter and a distal bore diameter, said distal bore diameter being greater than said proximal bore diameter.

9. The modular transporter of claim 1, wherein said mating connector comprises a first mating sealing surface having a first geometry and a second mating sealing surface having a second geometry, said first mating sealing surface configured to mate with a geometrically complementary first receiving sealing surface of said receiving connector, and said second mating sealing surface configured to mate with a geometrically complementary second receiving sealing surface of said receiving connector.

10. The modular transporter of claim 1, wherein said base may be folded about a lateral axis.

11. The modular transporter of claim 1, wherein said modular transporter is autonomous.

12. A universal chassis, comprising:
a base, said base comprising:
a top, a bottom, and sidewalls extending therebetween, said sidewalls having complex geometric surfaces configured to mate with geometrically complementary engagement surfaces of a user module;
a receiving/mating quick connector configured to mate with a mating/receiving quick connector of said user module; and
a plurality of suspension arm connectors, each of said plurality of suspension arm connectors configured to be coupled with a corresponding removeably connectable suspension arm at a proximal portion of said suspension arm, and a distal portion of each said suspension arm configured to be coupled with a corresponding wheel.

13. The universal chassis of claim 12, wherein said universal chassis is configurable in a plurality of transport configurations, including a four-wheeled configuration, a three-wheeled configuration, and a two-wheeled configuration.

14. The universal chassis of claim 12, wherein each of said plurality of suspension arm connectors are spring unit seats, each of said spring unit seats being configured to receive a spring unit, each spring unit configured to couple said proximal portion of said removeably connectable suspension arm with said base.

15. The universal chassis of claim 12, wherein said receiving/mating quick connector comprises a receiving bore, said receiving bore having a proximal bore diameter and a distal bore diameter, said distal bore diameter greater than said proximal bore diameter, and said mating/receiving quick connector comprising a shaft having a proximal diameter and a distal diameter, said proximal diameter greater than said distal diameter, said receiving bore adapted to receive said shaft.

16. A linking mechanism for moving a modular storage system between an engagement/unloading position and a transport position, said linking mechanism comprising:
a plurality of links, including: a storage connecting link, a vertical link, and a vehicle link;
said storage connecting link having a horizontal storage link portion and a vertical storage link portion, said vertical storage link configured to link with said modular storage system;
said vertical link having a vertical link top portion and a vertical link bottom portion, said vertical link top portion pivotably coupled with said horizontal storage link portion at a first top linking point; and
said vehicle link having a vehicle link proximal end and a vehicle link distal end, and said vehicle link proximal end pivotably coupled with said vertical link bottom portion at a first bottom linking point.

17. The linking mechanism of claim 16, wherein said linking mechanism further comprises a support link having a support link top portion and a support link bottom portion, said support link top portion pivotably coupled with said horizontal storage link portion at a second top linking point, and said support link bottom portion pivotably coupled with said vehicle link at a second bottom linking point.

18. The linking mechanism of claim 16, wherein said storage connecting link comprises a kinematic rotational joint for rotating said modular storage system.

19. The linking mechanism of claim 16, wherein said linking mechanism further comprises a plurality of cam locking systems moveable between a locked position and an unlocked position and at least one of said plurality of cam locking systems configured to mate with a locking system retainer located on said modular storage system, said plurality of cam locking systems each having an eccentric locking plate adapted to engage a recessed portion of said locking system retainer for moving one of said plurality of cam locking systems into said locked position.

20. A spring unit, comprising:
a cam hub;
a plurality of cam elements extending from said cam hub, said cam elements being rotatable about an axis of rotation;
a plurality of stops, each stop being engageable by a corresponding cam element;
said cam elements and said stops being disposed in such a way that as said plurality of cam elements are rotated about said axis of rotation, the stiffness of said spring unit progressively stiffens.

21. The spring unit of claim 20, wherein said spring unit further comprises a compression spring disposed adjacent to each of said stops.

22. The spring unit of claim 20, wherein said spring unit further comprises a compression spring disposed on both sides of each stop.
